(19) United States
(12) Patent Application Publication
(10) Pub. No.: US 2023/0014220 A1
(43) Pub. Date: Jan. 19, 2023

(54) IMAGE PROCESSING SYSTEM, IMAGE PROCESSING DEVICE, AND COMPUTER-READABLE RECORDING MEDIUM STORING IMAGE PROCESSING PROGRAM

(71) Applicant: FUJITSU LIMITED, Kawasaki-shi (JP)

(72) Inventors: Tomonori KUBOTA, Kawasaki (JP); Takanori Nakao, Kawasaki (JP)

(73) Assignee: FUJITSU LIMITED, Kawasaki-shi (JP)

(21) Appl. No.: 17/955,595

(22) Filed: Sep. 29, 2022

Related U.S. Application Data
(63) Continuation of application No. PCT/JP2020/020742, filed on May 26, 2020.

(51) Int. Cl. G06T 9/00; G06T 7/246; G06V 10/25; G06V 10/44; G06V 10/771

(52) U.S. Cl. CPC G06T 9/00; G06T 7/246; G06V 10/25; G06V 10/44; G06V 10/771

(57) ABSTRACT

An image processing system includes: a memory; and a processor coupled to the memory and configured to: generate information that indicates a feature portion that affects image recognition processing, by executing image recognition processing on first image data acquired at a first time; predict information that indicates the feature portion at a second time after the first time, based on the information that indicates the feature portion at the first time; and encode second image data acquired at the second time, by using a compression rate based on the predicted information that indicates the feature portion.

### CROSS-REFERENCE TO RELATED APPLICATION

This application is a continuation application of International Application PCT/JP2020/020742 filed on May 26, 2020 and designated the U.S., the entire contents of which are incorporated herein by reference.

### FIELD

The embodiments discussed herein are related to an image processing system, an image processing device, and an image processing program.

### BACKGROUND

Typically, in a case where image data is recorded or transmitted, a data size is reduced by executing encoding processing in advance, and a recording cost and a transmission cost are reduced.

Japanese Laid-open Patent Publication No. 2009-027563 is disclosed as related art.

### SUMMARY

According to an aspect of the embodiments, an image processing system includes: a memory; and a processor coupled to the memory and configured to: generate information that indicates a feature portion that affects image recognition processing, by executing image recognition processing on first image data acquired at a first time; predict information that indicates the feature portion at a second time after the first time, based on the information that indicates the feature portion at the first time; and encode second image data acquired at the second time, by using a compression rate based on the predicted information that indicates the feature portion.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an example of a system configuration of an image processing system;

FIGS. 2A and 2B are diagrams illustrating an example of hardware configurations of a cloud device and an edge device;

FIG. 3 is a first diagram illustrating a specific example of a functional configuration and processing of a map generation unit of the cloud device;

FIG. 4 is a second diagram illustrating a specific example of the functional configuration and the processing of the map generation unit of the cloud device;

FIG. 5 is a first diagram illustrating a specific example of processing of a buffer unit of the edge device;

FIG. 6 is a first diagram illustrating a specific example of a functional configuration and processing of an analysis unit of the edge device;

FIG. 7 is a first diagram illustrating a specific example of a functional configuration and processing of a compression rate determination unit of the edge device;

FIG. 8 is a diagram illustrating a specific example of a functional configuration and processing of an encoding unit of the edge device;

FIG. 9 is a first flowchart illustrating a flow of encoding processing by the image processing system;

FIG. 10 is a second diagram illustrating an example of the system configuration of the image processing system;

FIG. 11 is a second diagram illustrating a specific example of the processing of the buffer unit of the edge device;

FIG. 12 is a first diagram illustrating a specific example of a functional configuration and processing of an analysis unit of the cloud device;

FIG. 13 is a second flowchart illustrating the flow of the encoding processing by the image processing system;

FIG. 14 is a third diagram illustrating an example of the system configuration of the image processing system;

FIG. 15 is a fourth diagram illustrating an example of the system configuration of the image processing system;

FIG. 16 is a third diagram illustrating a specific example of the processing of the buffer unit of the edge device;

FIG. 17 is a second diagram illustrating a specific example of the functional configuration and the processing of the analysis unit of the cloud device;

FIG. 18 is a third flowchart illustrating the flow of the encoding processing by the image processing system;

FIG. 19 is a fifth diagram illustrating an example of the system configuration of the image processing system;

FIG. 20 is a fourth diagram illustrating a specific example of the processing of the buffer unit of the edge device;

FIG. 21 is a second diagram illustrating a specific example of the functional configuration and the processing of the analysis unit of the edge device;

FIG. 22 is a second diagram illustrating a specific example of the functional configuration and the processing of the compression rate determination unit of the edge device;

FIG. 23 is a fourth flowchart illustrating the flow of the encoding processing by the image processing system;

FIG. 24 is a sixth diagram illustrating an example of the system configuration of the image processing system; and

FIG. 25 is a conceptual diagram illustrating an image processing system that can perform conversion to a map including information having a different granularity.

### DESCRIPTION OF EMBODIMENTS

On the other hand, in recent years, there have been an increasing number of cases in which image data is recorded or transmitted for the purpose of use for image recognition processing by artificial intelligence (AI).

However, typical encoding processing is executed based on shapes or properties that can be grasped based on concepts of humans, and is not executed based on a feature portion (feature portion that cannot be necessarily divided by a boundary according to concepts of human) focused by the AI at the time of image recognition processing. Therefore, it is requested to execute encoding processing suitable for image recognition processing by the AI.

On the other hand, specifying the feature portion that is focused by the AI at the time of image recognition processing takes a certain period of time. Therefore, even if it is attempted to execute encoding processing as reflecting a compression rate based on the specified feature portion, the feature portion may be already moved in image data to be encoded. In such a case, the compression rate based on the specified feature portion is not reflected at an appropriate position in the image data to be encoded.

According to one aspect, an object is to implement encoding processing reflecting a compression rate suitable for image recognition processing.

Hereinafter, each embodiment will be described with reference to the attached drawings. Note that, in the description here and the drawings, components having substantially the same functional configuration are denoted by the same reference numerals, and redundant description is omitted.

### First Embodiment

### <System Configuration of Image Processing System>

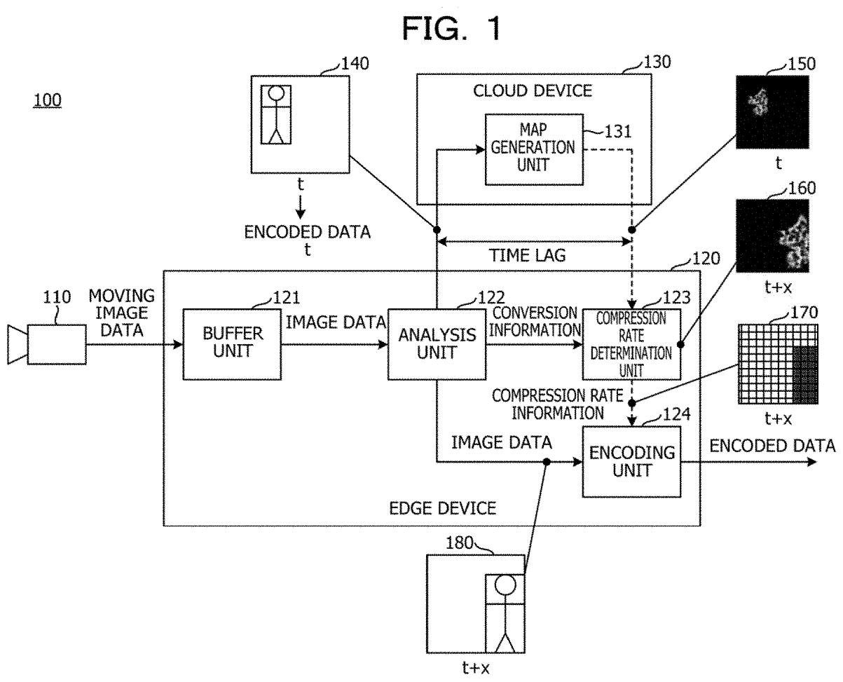

First, a system configuration of an image processing system according to a first embodiment will be described. FIG. 1 is a first diagram illustrating an example of a system configuration of the image processing system. As illustrated in FIG. 1, an image processing system 100 includes an imaging device 110, an edge device 120, and a cloud device 130.

The imaging device 110 performs imaging at a predetermined frame period and transmits moving image data to the edge device 120.

The edge device 120 is an example of an image processing device and encodes the moving image data transmitted from the imaging device 110 in frame units and outputs encoded data. The edge device 120 acquires a map from the cloud device 130 for image data of each frame when encoding the moving image data in frame units and reflects a compression rate according to the acquired map. Note that the map here is a map in which a feature portion focused by the AI when the AI executes image recognition processing is visualized. In the present embodiment, the map is generated by analyzing an image recognition unit (to be described in detail later) that executes the image recognition processing and specifying a feature portion that affects the image recognition processing.

An image processing program is installed in the edge device 120, and execution of the program causes the edge device 120 to function as a buffer unit 121, an analysis unit 122, a compression rate determination unit 123, and an encoding unit 124.

The buffer unit 121 buffers a predetermined number of pieces of image data of each frame included in the moving image data transmitted from the imaging device 110.

The analysis unit 122 reads image data 140 buffered by the buffer unit 121 at a first time (=t), notifies the encoding unit 124 of the image data 140, and encodes the image data 140, and then, transmits the encoded data to the cloud device 130. Note that the encoding unit 124 encodes the image data 140 buffered at the first time (=t) using compression rate information generated based on image data buffered at a time=t−x (however, here, detailed description of encoding processing is omitted).

Furthermore, the analysis unit 122 reads image data 180 buffered at a second time (=t+x) that is a predetermined time (=x) after the first time (=t) from the buffer unit 121 and notifies the encoding unit 124 of the image data 180. Furthermore, the analysis unit 122 calculates a change amount of the image data 180 buffered at the second time (=t+x) from the image data buffered at the first time (=t). Moreover, the analysis unit 122 generates conversion information used to predict a map at the second time (=t+x) based on the calculated change amount and notifies the compression rate determination unit 123 of the conversion information.

The compression rate determination unit 123 acquires a map 150 that is a map generated by the cloud device 130 and corresponds to the image data 140 buffered at the first time (=t). Furthermore, the compression rate determination unit 123 predicts a map 160 corresponding to the image data 180 buffered at the second time (=t+x) by converting the acquired map 150 using the conversion information notified by the analysis unit 122.

Moreover, the compression rate determination unit 123 determines a compression rate, on the basis of the calculated map 160, that is used when the image data 180 buffered at the second time (=t+x) is encoded in processing block units at the time of the encoding processing. The compression rate determination unit 123 notifies the encoding unit 124 of the compression rate of each processing block as compression rate information 170.

The encoding unit 124 encodes the image data 180 that is notified by the analysis unit 122 and is buffered at the second time (=t+x), using the compression rate information 170 notified by the compression rate determination unit 123 and generates encoded data.

On the other hand, an analysis program is installed in the cloud device 130, and execution of the program causes the cloud device 130 to function as a map generation unit 131. Note that, although the cloud device 130 further includes a decoding unit that decodes the encoded data (encoded data obtained by encoding image data (for example, image data 140)) transmitted from the edge device 120, the decoding unit is omitted in FIG. 1.

The map generation unit 131 is an example of a generation unit. The map generation unit 131 acquires image data that is transmitted from the edge device 120 and is decoded by the decoding unit (for example, image data 140). Furthermore, in the map generation unit 131, the image recognition unit executes the image recognition processing on the acquired image data, using a convolutional neural network (CNN). Furthermore, the map generation unit 131 generates a map (for example, map 150) in which a feature portion that affects the image recognition processing is visualized, based on structure information of the image recognition unit when executing the image recognition processing.

Moreover, the map generation unit 131 transmits the generated map to the edge device 120. Note that, in the present embodiment, it is assumed that a time lag from a time when the edge device 120 transmits the image data 140 to the cloud device 130 to a time when the edge device 120 receives the map 150 from the cloud device 130 be less than a predetermined time x.

### <Hardware Configurations of Cloud Device And Edge Device>

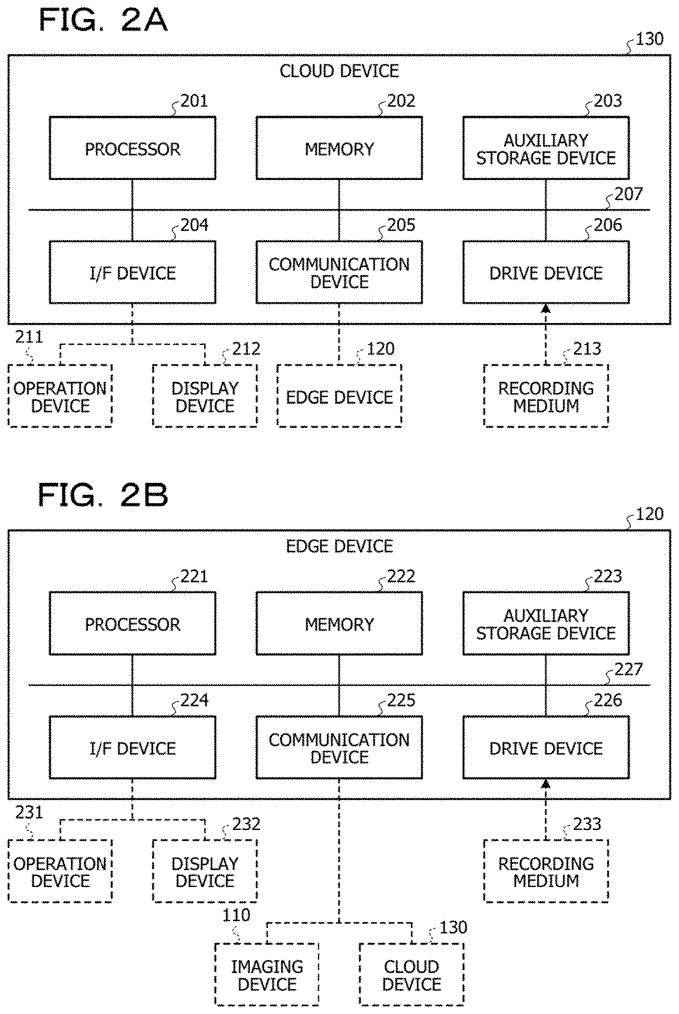

Next, hardware configurations of the cloud device 130 and the edge device 120 will be described. FIGS. 2A and 2B are diagrams illustrating an example of the hardware configurations of the cloud device and the edge device. Of FIGS. 2A and 2B, FIG. 2A is a diagram illustrating an example of the hardware configuration of the cloud device 130. As illustrated in FIG. 2A, the cloud device 130 includes a processor 201, a memory 202, an auxiliary storage device 203, and interface (I/F) device 204, a communication device 205, and a drive device 206. Note that pieces of the hardware of the cloud device 130 are connected to each other via a bus 207.

The processor 201 includes various arithmetic devices such as a central processing unit (CPU) or a graphics processing unit (GPU). The processor 201 reads various programs (for example, analysis program or the like) on the memory 202 and executes the program.

The memory 202 includes a main storage device such as a read only memory (ROM) or a random access memory (RAM). The processor 201 and the memory 202 form a so-called computer. The processor 201 executes various programs read on the memory 202 so that the computer implements various functions of the cloud device 130.

The auxiliary storage device 203 stores various programs and various types of data used when the various programs are executed by the processor 201.

The I/F device 204 is a connection device that connects an operation device 211 and a display device 212 that are exemplary external devices. The I/F device 204 receives an operation on the cloud device 130 via the operation device 211. Furthermore, the I/F device 204 outputs a result of the processing by the cloud device 130 and displays the result via the display device 212.

The communication device 205 is a communication device for communicating with another device. The cloud device 130 communicates with the edge device 120 via the communication device 205.

The drive device 206 is a device to which a recording medium 213 is set. The recording medium 213 here includes a medium that optically, electrically, or magnetically records information, such as a compact disc read only memory (CD-ROM), a flexible disk, or a magneto-optical disk. Furthermore, the recording medium 213 may include a semiconductor memory or the like that electrically records information, such as a ROM or a flash memory.

Note that various programs installed in the auxiliary storage device 203 are installed, for example, by setting the distributed recording medium 213 in the drive device 206 and reading the various programs recorded in the recording medium 213 by the drive device 206. Alternatively, various programs installed in the auxiliary storage device 203 may be installed by being downloaded from a network via the communication device 205.

On the other hand, FIG. 2B is a diagram illustrating an example of the hardware configuration of the edge device 120. As illustrated in FIG. 2B, the hardware configuration of the edge device 120 is similar to the hardware configuration of the cloud device 130.

However, in a case of the edge device 120, an image processing program is installed in an auxiliary storage device 223. Furthermore, in a case of the edge device 120, the edge device 120 communicates with the imaging device 110 and the cloud device 130 via a communication device 225.

### <Specific Example of Functional Configuration and Processing of Cloud Device>

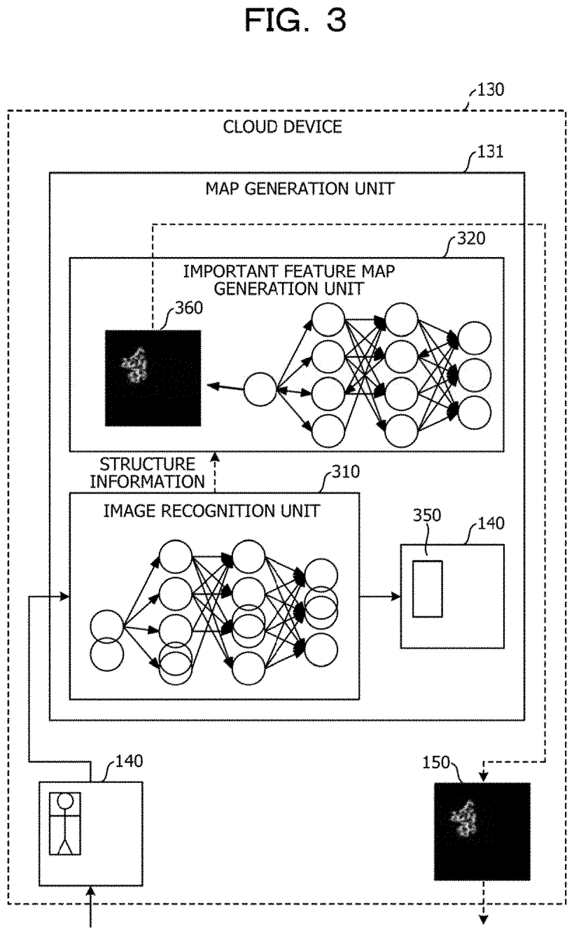

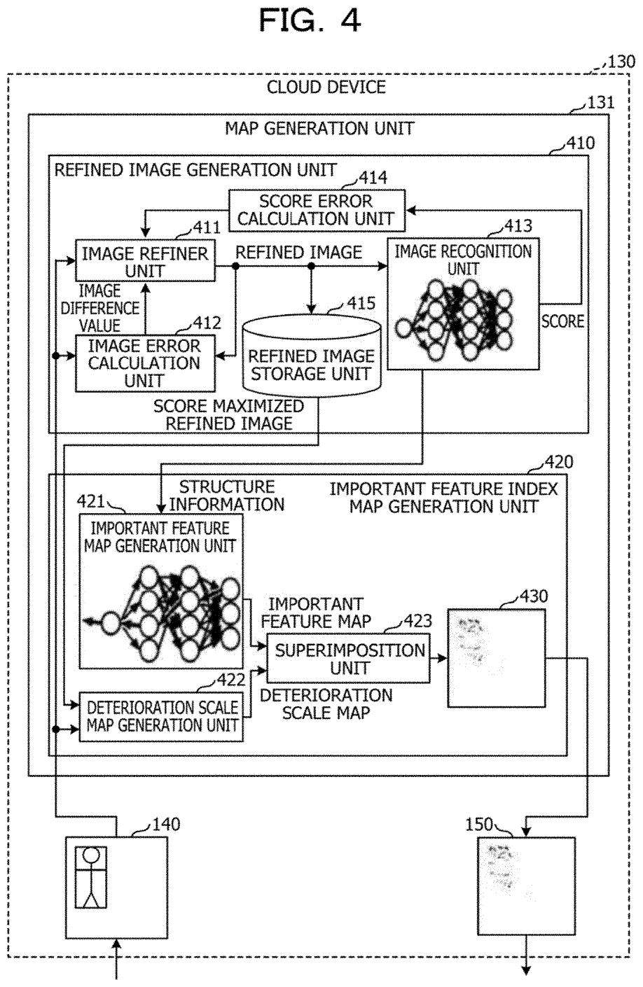

Next, specific examples (two types) of a functional configuration and processing of the map generation unit 131 of the cloud device 130 will be described with reference to FIGS. 3 and 4.
(1) First Specific Example of Functional Configuration And Processing of Map Generation Unit

FIG. 3 is a first diagram illustrating a specific example of the functional configuration and the processing of the map generation unit of the cloud device. As illustrated in FIG. 3, the map generation unit 131 includes an image recognition unit 310 and an important feature map generation unit 320.

When the image data (for example, image data 140), which is transmitted from the edge device 120 and is decoded by the decoding unit, is input to the image recognition unit 310, the image data 140 is forward propagated by the CNN of the image recognition unit 310. As a result, a recognition result (for example, label) regarding an object 350 to be recognized included in the image data 140 is output from an output layer of the CNN. Note that, here, it is assumed that the label output from the image recognition unit 310 be a correct answer label.

The important feature map generation unit 320 generates an “important feature map”, based on the structure information of the image recognition unit 310, by using a back propagation (BP) method, a guided back propagation (GBP) method, a selective BP method, or the like. The important feature map is a map, in which the feature portion that affects the image recognition processing is visualized, in the image data, based on the structure information of the image recognition unit 310 when the image recognition processing is executed.

Note that the BP method is a method of calculating an error of each label from a classification probability obtained by executing the image recognition processing on the image data for which the correct answer label is output as the recognition result and imaging a magnitude of a gradient obtained by performing backpropagation to an input layer so as to visualize a feature portion. Furthermore, the GBP method is a method of visualizing a feature portion by forming an image of only positive values of gradient information as the feature portion.

Moreover, the selective BP method is a method of performing processing using the BP method or the GBP method after maximizing only the error of the correct answer label. In a case of the selective BP method, a feature portion to be visualized is a feature portion that affects only a score of the correct answer label.

The example in FIG. 3 illustrates a state where an important feature map 360 is generated by the selective BP method. The important feature map generation unit 320 transmits the generated important feature map 360 to the edge device 120 as the map 150.
(2) Second Specific Example of Functional Configuration And Processing of Map Generation Unit

FIG. 4 is a second diagram illustrating the specific example of the functional configuration and the processing of the map generation unit of the cloud device. In a case of FIG. 4, the map generation unit 131 includes a refined image generation unit 410 and an important feature index map generation unit 420.

Moreover, the refined image generation unit 410 includes an image refiner unit 411, an image error calculation unit 412, an image recognition unit 413, and a score error calculation unit 414.

The image refiner unit 411 generates refined image data from the image data (for example, image data 140) decoded by the decoding unit, using the CNN as an image data generation model.

Note that the image refiner unit 411 changes the image data 140 so as to maximize the score of the correct answer label when the image recognition unit 413 executes the image recognition processing using the generated refined image data. Furthermore, the image refiner unit 411 generates refined image data so that a change amount from the image data 140 (difference between refined image data and image data 140) is reduced, for example. As a result, the image refiner unit 411 can generate image data (refined image data) that is visually close to the image data (image data 140) before being changed.

For example, the image refiner unit 411
learns the CNN included in the image refiner unit 411 so as to minimize
an error (score error) between a score when the image recognition processing is executed using the generated refined image data and a score obtained by maximizing the score of the correct answer label and
an image difference value that is a difference between the generated refined image data and the image data 140.

The image error calculation unit 412 calculates a difference between the image data 140 and the refined image data output from the image refiner unit 411 during learning of the CNN and inputs the image difference value into the image refiner unit 411. The image error calculation unit 412 calculates the image difference value, for example, by calculating a difference for each pixel (L1 difference) or performing a structural similarity (SSIM) calculation and inputs the image difference value into the image refiner unit 411.

The image recognition unit 413 includes a learned CNN that executes the image recognition processing using the refined image data generated by the image refiner unit 411 as an input and outputs a score of a label of a recognition result. Note that the score output by the image recognition unit 413 is notified to the score error calculation unit 414.

The score error calculation unit 414 calculates an error between the score notified by the image recognition unit 413 and the score obtained by maximizing the score of the correct answer label and notifies the image refiner unit 411 of the score error. The score error notified by the score error calculation unit 414 is used for CNN learning by the image refiner unit 411.

Note that a refined image output from the image refiner unit 411 during learning of the CNN included in the image refiner unit 411 is stored in a refined image storage unit 415. Learning of the CNN included in the image refiner unit 411 is performed
for a predetermined number of times of learning (for example, maximum number of times of learning=N times), or
until the score of the correct answer label exceeds a predetermined threshold value, or
until the score of the correct answer label exceeds the predetermined threshold value and the image difference value falls below a predetermined threshold value.

Hereinafter, the refined image data when the score of the correct answer label output by the image recognition unit 413 is maximized is referred to as “score maximized refined image data”.

Subsequently, details of the important feature index map generation unit 420 will be described. As illustrated in FIG. 4, the important feature index map generation unit 420 includes an important feature map generation unit 421, a deterioration scale map generation unit 422, and a superimposition unit 423.

The important feature map generation unit 421 acquires structure information of the image recognition unit 413 when the image recognition processing is executed using the score maximized refined image data as an input, from the image recognition unit 413. Furthermore, the important feature map generation unit 421 generates an important feature map based on the structure information of the image recognition unit 413, by using the BP method, the GBP method, or the selective BP method.

The deterioration scale map generation unit 422 generates a “deterioration scale map” based on the image data (for example, image data 140) decoded by the decoding unit and the score maximized refined image data. The deterioration scale map is a map indicating a changed portion and a change degree of each changed portion when the score maximized refined image data is generated from the image data 140.

The superimposition unit 423 generates an important feature index map 430 by superimposing the important feature map generated by the important feature map generation unit 421 and the deterioration scale map generated by the deterioration scale map generation unit 422. The important feature index map 430 is a map in which a feature portion that affects the image recognition processing is visualized in image data.

The important feature index map generation unit 420 transmits the generated important feature index map 430 to the edge device 120 as the map 150.
(3) Other Map Generation Methods by Map Generation Unit

As described in (1) and (2) above, the map generation unit 131
instead of determining a compression rate based on humans,
in order to determine a compression rate based on AI,
generates a map used to determine the compression rate based on an influence degree on recognition accuracy regarding a feature portion that is focused when the AI executes the image recognition processing. Then, based on the map generated by the map generation unit 131, finally, the edge device 120 executes the encoding processing on image data.

For example, in (1) and (2) described above, only two types of map generation methods in a case where a map is generated for such a purpose are described. For the same purpose, a map may be generated by a method different from (1) and (2) described above.

For example, the compression rate may be determined by specifying the feature portion focused when the AI executes the image recognition processing, using a feature map that is an output of each layer of the CNN when the image recognition processing is executed.

Alternatively, in (1) described above, the compression rate may be determined based on a change in the feature portion focused by the AI when the AI executes the image recognition processing, using pieces of image data with different image qualities as inputs.

Alternatively, in (2) described above, refined image data for which recognition accuracy when the image recognition processing is executed by the image recognition unit 413 is set as a predetermined standard may be regarded as the score maximized refined image data. In this case, the important feature index map generation unit 420 generates the important feature index map 430, using the image data input to the map generation unit 131 and the refined image data to be the predetermined standard.

### <Functional Configuration of Each Unit of Edge Device>

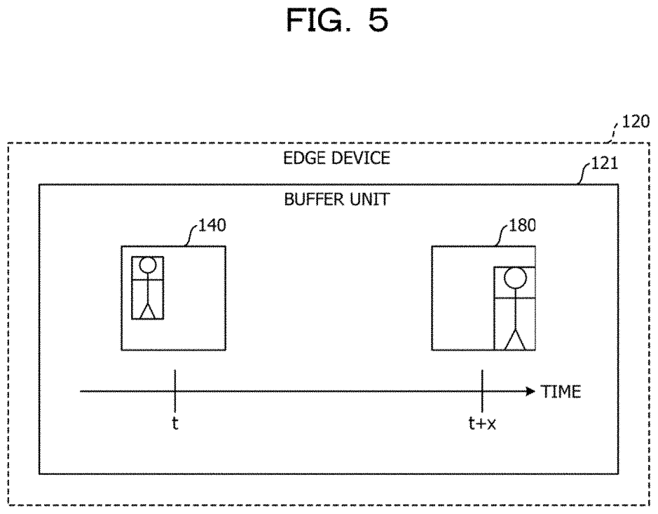

Next, a specific example of a functional configuration and/or processing of each unit of the edge device 120 will be described with reference to FIGS. 5 to 8.
(1) Specific Example of Processing of Buffer Unit

First, a specific example of processing of the buffer unit 121 will be described. FIG. 5 is a first diagram illustrating a specific example of the processing of the buffer unit of the edge device. As illustrated in FIG. 5, the buffer unit 121 of the edge device 120 buffers a predetermined number of pieces of image data of each frame included in the moving image data transmitted from the imaging device 110.

The example in FIG. 5 illustrates a state where the buffer unit 121 buffers pieces of image data as many as the number of frames corresponding to the predetermined time x. For example, when it is assumed that the current time be the second time (=t+x), the buffer unit 121 buffers image data up to the first time (=t) that is a past time from the current time at least by the predetermined time x.

Note that, in the example in FIG. 5, image data at each time between the first time (=t) and the second time (=t+x) is omitted. However, it is assumed that the buffer unit 121 buffer a plurality of pieces of image data at each time between the first time (=t) and the second time (=t+x).
(2) Specific Example of Functional Configuration And Processing of Analysis Unit

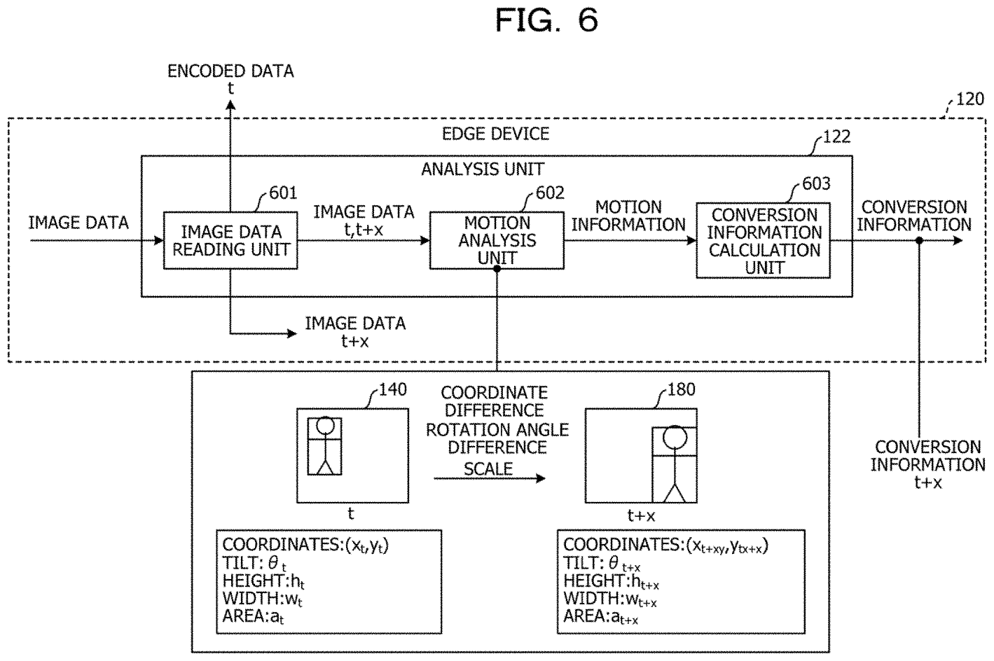

Next, a specific example of a functional configuration and processing of the analysis unit 122 will be described. FIG. 6 is a first diagram illustrating a specific example of a functional configuration and processing of the analysis unit of the edge device. As illustrated in FIG. 6, the analysis unit 122 includes an image data reading unit 601, a motion analysis unit 602, and a conversion information calculation unit 603.

The image data reading unit 601 reads the image data buffered by the buffer unit 121, notifies the encoding unit 124 of the image data, and encodes the image data, and then, transmits the encoded data to the cloud device 130. Furthermore, the image data reading unit 601 notifies the motion analysis unit 602 of the read image data.

For example, the image data reading unit 601 reads image data at the first time (=t) buffered by the buffer unit 121, notifies the encoding unit 124 of the image data, and encodes the image data, and then, transmits the encoded data to the cloud device 130. Furthermore, the image data reading unit 601 notifies the motion analysis unit 602 of the read image data at the first time (=t).

Furthermore, the image data reading unit 601 reads image data buffered by the buffer unit 121 after the predetermined time x has elapsed and notifies the motion analysis unit 602 and the encoding unit 124 of the image data.

For example, the image data reading unit 601 reads image data at the second time (=t+x) buffered by the buffer unit 121 and notifies the motion analysis unit 602 and the encoding unit 124 of the image data.

The motion analysis unit 602 calculates a change amount of the image data generate in the predetermined time x based on the pair of the image data notified from the image data reading unit 601 and generates motion information based on the calculated change amount.

For example, it is assumed that the motion analysis unit 602 acquire the image data 140 at the first time (=t) and the image data 180 at the second time (=t+x) as the pair of image data notified from the image data reading unit 601.

In this case, the motion analysis unit 602 calculates, for example, features such as coordinates, tilt, a height, a width, or an area of an object included in the image data 140. Furthermore, the motion analysis unit 602 calculates, for example, features such as coordinates, tilt, a height, a width, or an area of an object included in the image data 180.

Moreover, the motion analysis unit 602 analyzes a motion of the object at the second time (=t+x), for example, by calculating a coordinate difference, a rotation angle difference, a vertical and horizontal scale ratio, or the like that is a change amount of the feature between the image data 180 and the image data 140 and generates the motion information. Furthermore, the motion analysis unit 602 notifies the conversion information calculation unit 603 of the generated motion information.

The conversion information calculation unit 603 generates conversion information used to predict
from the map 160 corresponding to the image data 140 at the first time (=t) transmitted from the cloud device 130
a map corresponding to the image data 180 at the second time (=t+x)
based on the motion information notified from the motion analysis unit 602. Furthermore, the conversion information calculation unit 603 notifies the compression rate determination unit 123 of the generated conversion information.

Note that a method of generating the motion information by the motion analysis unit 602 is not limited to the above. For example, the motion information may be generated by calculating features such as coordinates, tilt, a height, a width, or an area of an object, from each piece of the image data buffered between the image data 140 and the image data 180 and using these auxiliary or subjectively.

Alternatively, from a plurality of pieces of encoded data among the encoded data obtained by encoding each piece of the image data buffered between the image data 140 and image data immediately before the image data 180,
information that indicates a motion of an object (for example, motion vector of encoded data or the like) and
information that indicates existence of the object (for example, information indicating encoding mode (intra prediction mode or inter prediction mode), information indicating distribution of coefficients, information indicating arrangement of quantized values, or the like)

may be calculated, and the motion information may be generated by auxiliary or subjectively using these.

Furthermore, when the motion analysis unit 602 generates the motion information,
one of
a method of directly analyzing the motion of the object in the image data and
a method of analyzing the motion of the object as a result of a motion of a feature that can be acquired without being aware of the object in the image data

may be user or both of the above may be complementarily used. Note that the feature that can be acquired without being aware of the object includes information that results in a link to the shape of the object, for example, edge information, corner information, information that indicates a change in color and brightness, image statistical information for each region, or the like. Alternatively, the feature that can be acquired without being aware of the object includes a feature that does not necessarily need to be grouped as an object when being calculated.
(3) Specific Example of Functional Configuration And Processing of Compression Rate Determination Unit

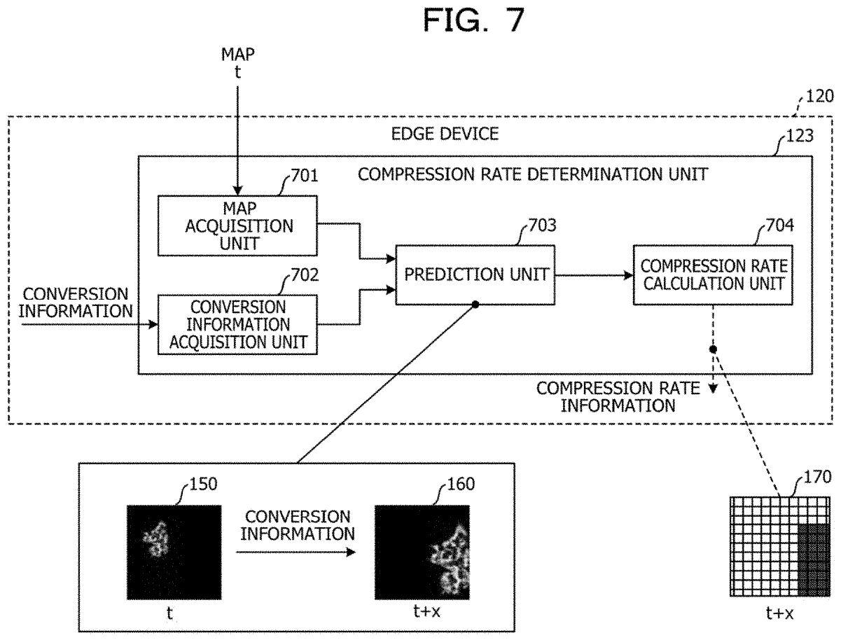

Next, a specific example of a functional configuration and processing of the compression rate determination unit 123 will be described. FIG. 7 is a first diagram illustrating a specific example of a functional configuration and processing of the compression rate determination unit of the edge device. As illustrated in FIG. 7, the compression rate determination unit 123 includes a map acquisition unit 701, a conversion information acquisition unit 702, a prediction unit 703, and a compression rate calculation unit 704.

The map acquisition unit 701 acquires a map (for example, map 150 corresponding to image data 140 at first time (=t)) from the cloud device 130 and notifies the prediction unit 703 of the map.

The conversion information acquisition unit 702 acquires the conversion information (for example, conversion information used to predict map 160 corresponding to image data 180 at second time (=t+x) from map 150 corresponding to image data 140 at first time (=t)) from the analysis unit 122. Furthermore, the conversion information acquisition unit 702 notifies the prediction unit 703 of the acquired conversion information.

The prediction unit 703 predicts the map 160 corresponding to the image data 180 at the second time (=t+x) from the map 150 corresponding to the image data 140 at the first time (=t), based on the conversion information notified by the conversion information acquisition unit 702 and notifies the compression rate calculation unit 704 of the map 160.

The compression rate calculation unit 704 generates the compression rate information 170 by determining the compression rate of each processing block used when the encoding unit 124 encodes the image data (image data 180 at second time (=t+x)), based on the map 160 notified by the prediction unit 703. For example, the compression rate calculation unit 704 aggregates each pixel value of the map 160 for each processing block and determines a compression rate according to the aggregation result so as to generate the compression rate information 170. The example in FIG. 7 illustrates that a compression rate of a hatched processing block is lower than a compression rate of a non-hatched processing block, in the compression rate information 170.
(4) Specific Example of Functional Configuration And Processing of Encoding Unit

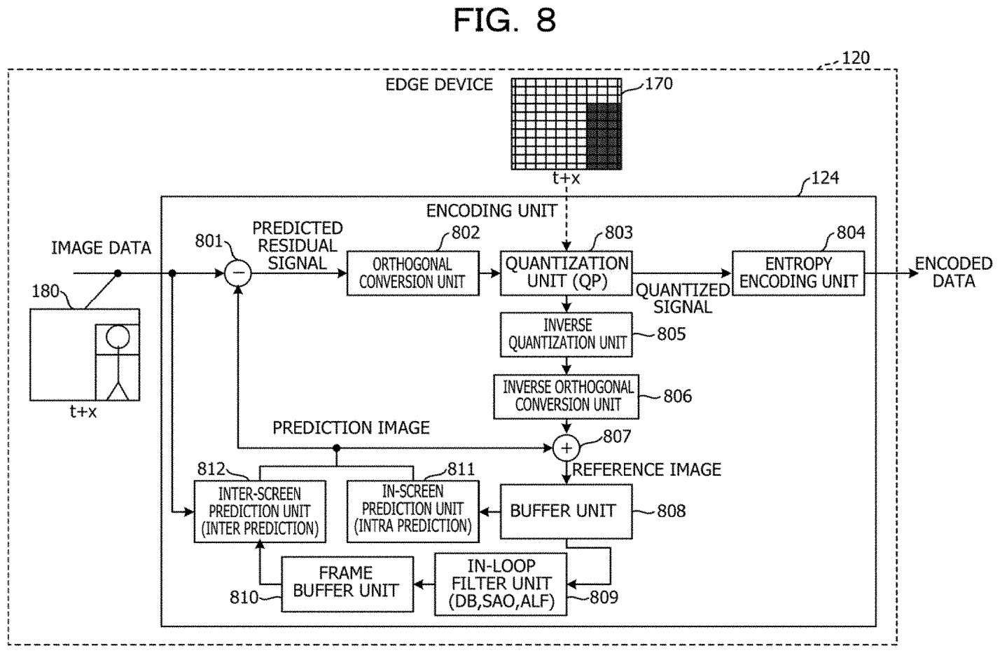

Next, a specific example of a functional configuration and processing of the encoding unit 124 will be described. FIG. 8 is a diagram illustrating a specific example of a functional configuration and processing of the encoding unit of the edge device. As illustrated in FIG. 8, the encoding unit 124 includes a difference unit 801, an orthogonal conversion unit 802, a quantization unit 803, an entropy encoding unit 804, an inverse quantization unit 805, and an inverse orthogonal conversion unit 806. Furthermore, the encoding unit 124 includes an addition unit 807, a buffer unit 808, an in-loop filter unit 809, a frame buffer unit 810, an in-screen prediction unit 811, and an inter-screen prediction unit 812.

The difference unit 801 calculates a difference between the image data (for example, image data 180 at second time (=t+x)) and predicted image data and outputs a predicted residual signal.

The orthogonal conversion unit 802 executes orthogonal conversion processing on the predicted residual signal output from the difference unit 801.

The quantization unit 803 quantizes the predicted residual signal on which the orthogonal conversion processing has been executed and generates a quantized signal. The quantization unit 803 generates the quantized signal using the compression rate information 170 including the compression rate determined for each processing block by the compression rate determination unit 123.

The entropy encoding unit 804 generates encoded data by executing entropy encoding processing on the quantized signal.

The inverse quantization unit 805 inverse-quantizes the quantized signal. The inverse orthogonal conversion unit 806 executes inverse orthogonal conversion processing on the quantized signal that has been inverse-quantized.

The addition unit 807 generates reference image data by adding the signal output from the inverse orthogonal conversion unit 806 and a prediction image. The buffer unit 808 stores the reference image data generated by the addition unit 807.

The in-loop filter unit 809 executes filter processing on the reference image data stored in the buffer unit 808. The in-loop filter unit 809
includes
a deblocking filter (DB),
a sample adaptive offset filter (SAO), and
an adaptive loop filter (ALF).

The frame buffer unit 810 stores the reference image data on which the filter processing has been executed by the in-loop filter unit 809, in frame units.

The in-screen prediction unit 811 performs in-screen prediction based on the reference image data and generates the predicted image data. The inter-screen prediction unit 812 performs motion compensation between frames using the input image data (for example, image data 180 at second time (=t+x)) and the reference image data and generates the predicted image data.

Note that the predicted image data generated by the in-screen prediction unit 811 or the inter-screen prediction unit 812 is output to the difference unit 801 and the addition unit 807.

Note that, in the above description, it is assumed that the encoding unit 124 execute the encoding processing using an existing moving image encoding method such as MPEG-2, MPEG-4, H.264, or HEVC. However, the encoding processing executed by the encoding unit 124 may be executed using any encoding method for controlling a compression rate through quantization, without limiting to these moving image encoding methods.

### <Flow of Encoding Processing by Image Processing System>

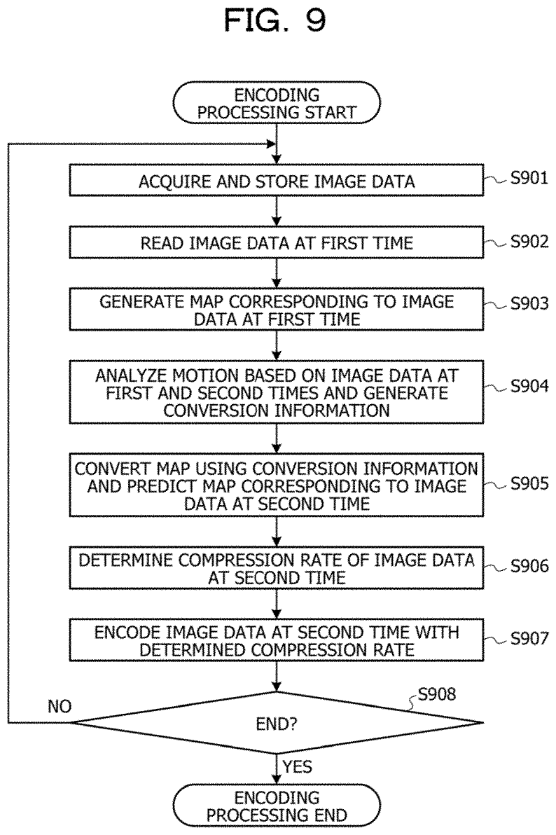

Next, a flow of encoding processing executed by the entire image processing system 100 will be described. FIG. 9 is a first flowchart illustrating the flow of the encoding processing by the image processing system. By starting imaging by the imaging device 110, the encoding processing illustrated in FIG. 9 starts.

In step S901, the buffer unit 121 of the edge device 120 acquires image data of each frame of the moving image data transmitted from the imaging device 110 and buffers the image data.

In step S902, the analysis unit 122 of the edge device 120 reads image data at the first time (=t) from the image data buffered by the buffer unit 121, notifies the encoding unit 124 of the image data, and encodes the image data, and then, transmits the image data to the cloud device 130.

In step S903, the map generation unit 131 of the cloud device 130 generates a map corresponding to the image data at the first time (=t) and transmits the map to the edge device 120.

In step S904, the analysis unit 122 of the edge device 120 reads image data at the second time (=t+x) from the buffer unit 121 and calculates a change amount from the image data at the first time (=t). As a result, the analysis unit 122 of the edge device 120 analyzes a motion of an object at the second time (=t+x) and generates motion information. Furthermore, the analysis unit 122 of the edge device 120 generates conversion information based on the generated motion information.

In step S905, the compression rate determination unit 123 of the edge device 120 converts a map corresponding to the image data at the first time (=t) using the conversion information and predicts a map corresponding to the image data at the second time (=t+x).

In step S906, the compression rate determination unit 123 of the edge device 120 determines a compression rate of each processing block used when the image data at the second time (=t+x) is encoded, based on the map corresponding to the image data at the second time (=t+x).

In step S907, the encoding unit 124 of the edge device 120 encodes the image data at the second time (=t+x), using the compression rate of each processing block determined by the compression rate determination unit 123.

In step S908, the edge device 120 determines whether or not to end the encoding processing. In a case where it is determined to continue the encoding processing in step S908 (a case of NO in step S908), the procedure returns to step S901. In this case, the image processing system 100 executes similar processing as advancing the first time (=t) by a frame period.

On the other hand, in a case where it is determined to end the encoding processing in step S908 (a case of YES in step S908), the encoding processing ends.

As is clear from the above description, the image processing system 100 according to the first embodiment generates the map in which the feature portion that affects the image recognition processing is visualized, by executing the image recognition processing on the image data acquired at the first time. Furthermore, the image processing system 100 according to the first embodiment predicts the map at the second time, based on the generated map at the first time and the motion of the object at the second time after the first time. Moreover, the image processing system 100 according to the first embodiment encodes the image data acquired at the second time, using the compression rate determined for each processing block based on the predicted map.

In this way, the image processing system 100 converts the map according to a time (predetermined time x) before the determined compression rate is reflected, when the compression rate is determined based on the map in which the feature portion that affects the image recognition processing is visualized, and predicts a map after the predetermined time has elapsed. As a result, the compression rate suitable for the image recognition processing can be reflected at an appropriate position in image data to be encoded.

As a result, according to the first embodiment, the encoding processing reflecting the compression rate suitable for the image recognition processing can be implemented.

### Second Embodiment

In the first embodiment described above, the map corresponding to the image data at the second time (=t+x) is predicted based on the map at the first time (=t) and the motion of the object at the second time (=t+x). On the other hand, in a second embodiment, the map corresponding to the image data at the second time (=t+x) is predicted based on a map corresponding to image data at a third time (=t+y(y<x)) and a motion of a region corresponding to an object at the third time. Hereinafter, regarding the second embodiment, differences from the first embodiment will be mainly described.

### <System Configuration of Image Processing System>

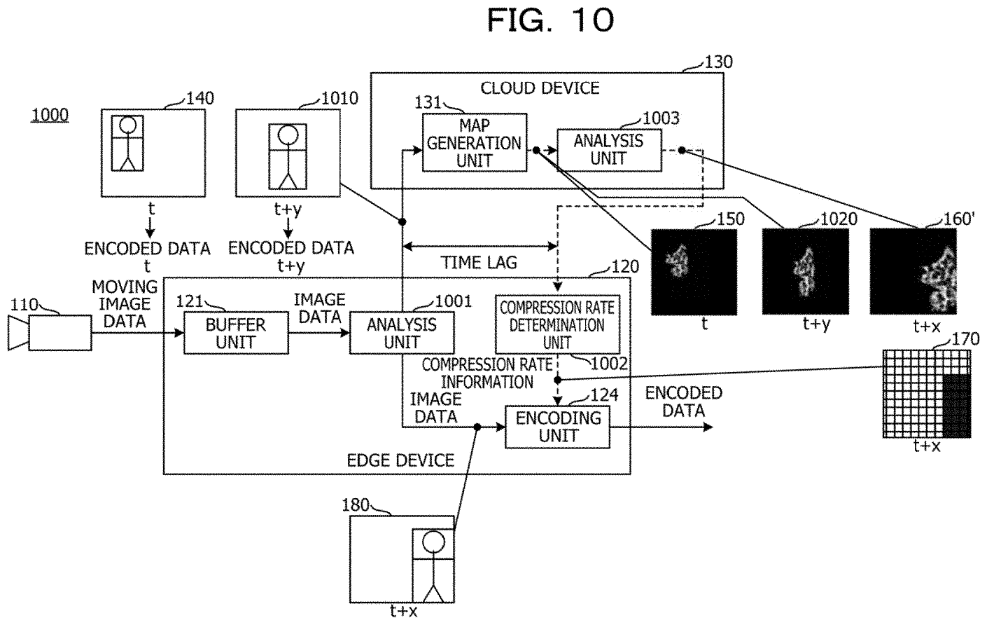

First, a system configuration of an image processing system according to the second embodiment will be described. FIG. 10 is a second diagram illustrating an example of the system configuration of the image processing system. As illustrated in FIG. 10, in a case of an image processing system 1000, there are the following differences from the image processing system 100 in FIG. 1.

For example, an analysis unit 1001 of an edge device 120 reads image data 1010 buffered at the third time (=t+y) that is a predetermined time (=y) after a first time (=t), notifies an encoding unit 124 of the image data 1010, and encodes the image data 1010. Then, the analysis unit 1001 of the edge device 120 transmits the encoded data obtained by encoding the image data 1010 buffered at the third time (=t+y) to a cloud device 130.

Note that, the third time (=t+y) is, for example,
a time obtained by adding a time y, in which
a time obtained by adding
the time y,
a transmission time taken when the image data 1010 at the third time is transmitted to the cloud device 130,
a generation time taken when a map 1020 corresponding to the image data 1010 at the third time is generated by the cloud device 130, and
a transmission time taken when the generated map 1020 is transmitted to the edge device 120
is adjusted to be substantially equal to the predetermined time x,
to the first time (=t).

Furthermore, a difference from the image processing system 100 in

FIG. 1 is a point that a compression rate determination unit 1002 of the edge device 120 generates compression rate information 170 based on a map 160′ transmitted from the cloud device 130.

Note that, as in the first embodiment described above, a plurality of pieces of buffered image data may exist between the third time (=t+y) and the second time (=t+x).

Furthermore, a difference from the image processing system 100 in FIG. 1 is a point that a map generation unit 131 of the cloud device 130 generates the map 1020 corresponding to the image data 1010 at the third time (=t+y).

Moreover, a difference from the image processing system 100 in FIG. 1 is a point that the cloud device 130 includes an analysis unit 1003, and the analysis unit 1003 predicts the map 160′ corresponding to the image data 180 at the second time (t+x) based on
a map 150 corresponding to image data 140 at the first time (=t) and
the map 1020 corresponding to the image data 1010 at the third time (=t+y).

### <Specific Example of Processing of Edge Device>

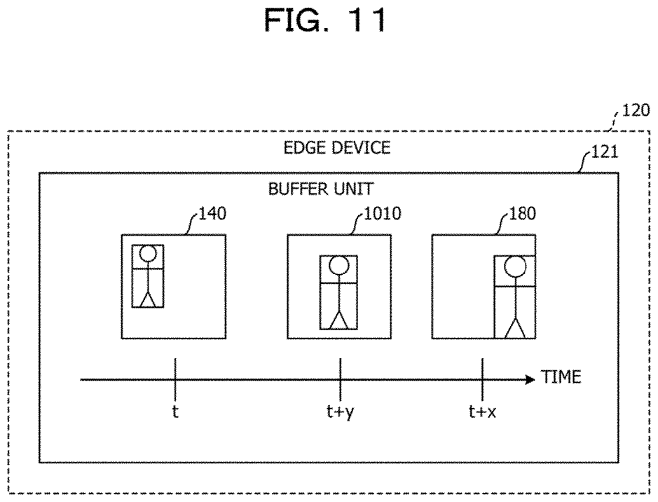

Next, a specific example of processing of the edge device 120 (here, specific example of processing of buffer unit 121) will be described. FIG. 11 is a second diagram illustrating a specific example of the processing of the buffer unit of the edge device. As illustrated in FIG. 11, the buffer unit 121 of the edge device 120 buffers a predetermined number of pieces of image data of each frame included in moving image data transmitted from an imaging device 110. Image data to be buffered by the buffer unit 121 of the edge device 120 in the second embodiment includes at least the image data 1010 at the third time (=t+y).

### <Specific Example of Functional Configuration and Processing of Cloud Device>

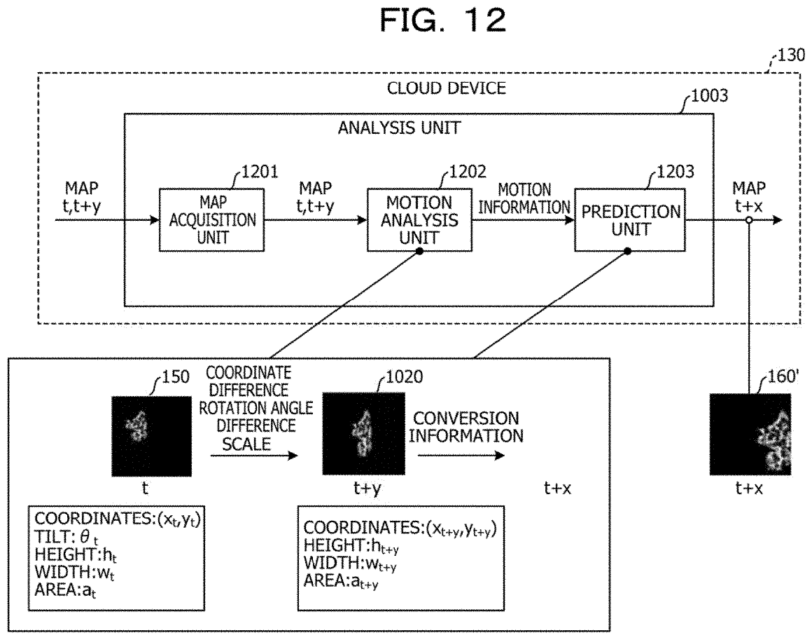

Next, a specific example of a functional configuration and processing of the analysis unit 1003 of the cloud device 130 will be described with reference to FIG. 12. FIG. 12 is a first diagram illustrating a specific example of a functional configuration and processing of the analysis unit of the cloud device.

As illustrated in FIG. 12, the analysis unit 1003 of the cloud device 130 includes a map acquisition unit 1201, a motion analysis unit 1202, and a prediction unit 1203.

The map acquisition unit 1201 acquires a pair of maps notified from the map generation unit 131. For example, the map acquisition unit 1201 acquires a pair of the map 150 corresponding to the image data 140 at the first time (=t) and the map 1020 corresponding to the image data 1010 at the third time (=t+y) that are generated by the map generation unit 131. Furthermore, the map acquisition unit 1201 notifies the motion analysis unit 1202 of the acquired pair of maps.

The motion analysis unit 1202 calculates a change amount of the map generated in the time y, based on the pair of maps notified by the map acquisition unit 1201 and generates motion information based on the calculated change amount.

For example, the motion analysis unit 1202 calculates features such as coordinates, tilt, a height, a width, or an area of a region corresponding to an object included in the map 150. Furthermore, for example, the motion analysis unit 1202 calculates features such as coordinates, tilt, a height, a width, or an area of a region corresponding to an object included in the map 1020.

Moreover, the motion analysis unit 1202 analyzes a motion of a region corresponding to an object at the third time (=t+y), for example, by calculating a coordinate difference, a rotation angle difference, a vertical and horizontal scale ratio, or the like that is a change amount of a feature between the map 150 and the map 1020 and generates the motion information. Furthermore, the motion analysis unit 1202 notifies the prediction unit 1203 of the generated motion information.

The prediction unit 1203 generates conversion information used to predict the map 160′; corresponding to the image data 180 at the second time (=t+x), from the map 1020 corresponding to the image data 1010 at the third time (=t+y), based on the motion information notified by the motion analysis unit 1202. Furthermore, the prediction unit 1203 predicts the map 160′ corresponding to the image data 180 at the second time (=t+x), from the map 1020 corresponding to the image data 1010 at the third time (=t+y), based on the generated conversion information. Note that the map 160′ predicted by the prediction unit 1203 is transmitted to the edge device 120.

### <Flow of Encoding Processing by Image Processing System>

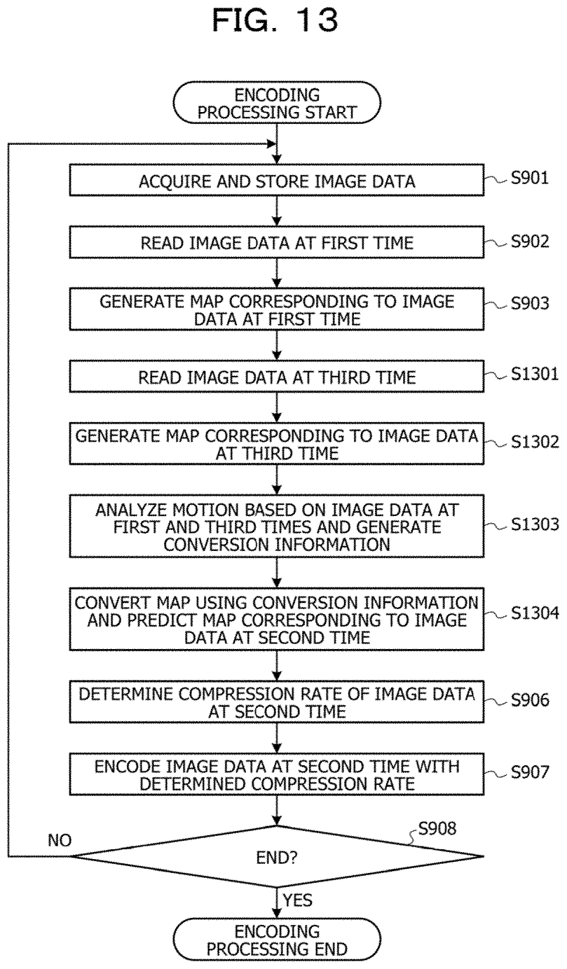

Next, a flow of encoding processing executed by the entire image processing system 1000 will be described. FIG. 13 is a second flowchart illustrating the flow of the encoding processing by the image processing system. The difference from FIG. 9 is steps S1301 to S1304.

In step S1301, the analysis unit 1001 of the edge device 120 reads image data at the third time (=t+y) from the image data buffered by the buffer unit 121, notifies the encoding unit 124 of the image data, and encodes the image data, and then, transmits the image data to the cloud device 130.

In step S1302, the map generation unit 131 of the cloud device 130 generates a map corresponding to the image data at the third time (=t+y).

In step S1303, the analysis unit 1003 of the cloud device 130 calculates a change amount of the map corresponding to the image data at the third time (=t+y) from the map corresponding to the image data at the first time (=t). As a result, the analysis unit 1003 of the cloud device 130 analyzes a motion of a region corresponding to an object at the third time (=t+y) and generates motion information. Furthermore, the analysis unit 1003 of the cloud device 130 generates conversion information used to predict the map corresponding to the image data at the second time (=t+x), based on the generated motion information.

In step S1304, the analysis unit 1003 of the cloud device 130 predicts the map corresponding to the image data at the second time (=t+x) by converting the map corresponding to the image data at the third time (=t+y), using the generated conversion information.

As is clear from the above description, the image processing system 1000 according to the second embodiment predicts the map corresponding to the image data at the second time based on the map corresponding to the image data at the third time and the motion of the region corresponding to the object at the third time. As a result, according to the image processing system 1000 according to the second embodiment, effects similar to the first embodiment described above can be achieved.

### Third Embodiment

In the first and second embodiments described above, the map corresponding to the image data at the second time (=t+x) is predicted using different methods, and the compression rate is determined using the map predicted by each of the methods.

On the other hand, in a third embodiment, a compression rate is determined using the map corresponding to the image data at the second time (=t+x) predicted in the first embodiment and the map corresponding to the image data at the second time (=t+x) predicted in the second embodiment. Hereinafter, differences from the first and second embodiments will be mainly described.

### <System Configuration of Image Processing System>

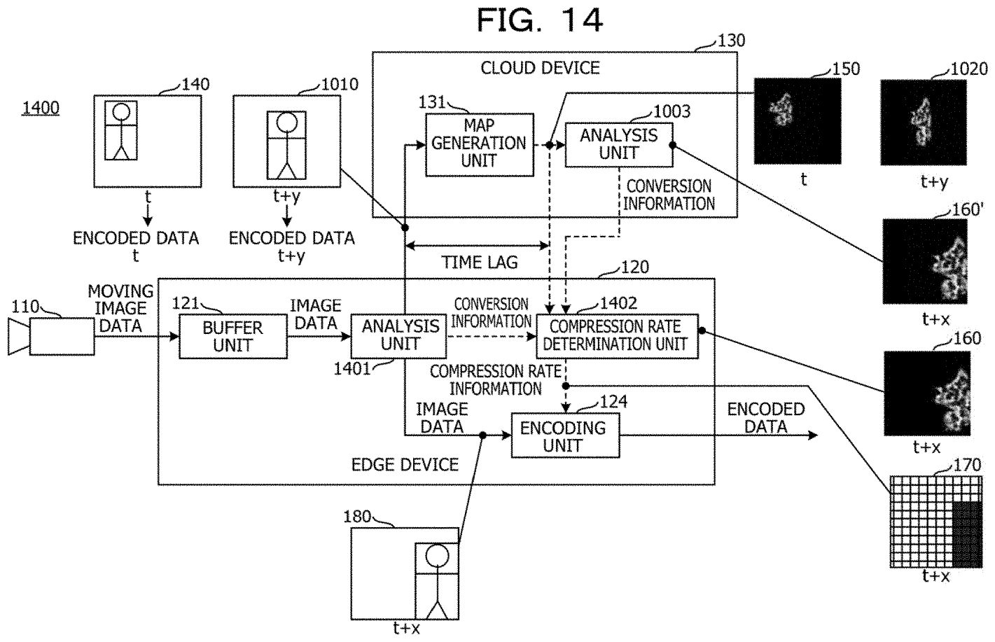

FIG. 14 is a third diagram illustrating an example of a system configuration of an image processing system. Differences from the image processing systems 100 or 1000 in FIG. 1 or 10 are an analysis unit 1401 and a compression rate determination unit 1402.

As illustrated in FIG. 14, in a case of an image processing system 1400, the analysis unit 1401 reads image data 140 buffered at the first time (=t), notifies an encoding unit 124 of the image data 140, and encodes the image data 140, and then, transmits the encoded data to the cloud device 130. Furthermore, the analysis unit 1401 reads image data 1010 buffered at the third time (=t+y) that is a predetermined time (=y) after the first time (=t), notifies the encoding unit 124 of the image data 1010, and encodes the image data 1010, and then, transmits the encoded data to the cloud device 130. Furthermore, the analysis unit 1401 reads image data 180 buffered at the second time (=t+x) that is a predetermined time (=x) after the first time (=t) (however, y<x), and notifies the encoding unit 124 of the image data 180. Furthermore, the analysis unit 1401 analyzes a motion of an object at the second time (=t+x) by calculating a change amount of the image data 180 buffered at the second time (=t+x) from the image data buffered at the first time (=t) and generates motion information. Moreover, the analysis unit 1401 generates conversion information based on the generated motion information and notifies the compression rate determination unit 1402 of the conversion information.

The compression rate determination unit 1402 acquires a map 150 that is a map generated by the cloud device 130 and corresponds to the image data at the first time (=t). Furthermore, the compression rate determination unit 1402 converts the acquired map 150 based on the conversion information notified from the analysis unit 1401 and predicts a map 160 corresponding to the image data 180 at the second time (=t+x).

Furthermore, the compression rate determination unit 1402 acquires a map 160′ that is a map generated by the cloud device 130 and corresponds to the image data at the second time (=t+x).

Furthermore, the compression rate determination unit 1402 determines a compression rate of each processing block used when the image data 180 at the second time (=t+x) is encoded based on the predicted map 160 and the acquired map 160′. Moreover, the compression rate determination unit 1402 notifies the encoding unit 124 of the compression rate determined for each processing block as compression rate information 170.

As is clear from the above description, the image processing system 1400 according to the third embodiment determines the compression rate based on the maps 160 and 160′ that correspond to the image data at the second time (=t+x) and predicted by different methods. As a result, according to the image processing system 1400 according to the third embodiment, the compression rate suitable for image recognition processing can be reflected at an appropriate position in the image data to be encoded.

As a result, according to the image processing system 1400 according to the third embodiment, encoding processing reflecting the compression rate suitable for the image recognition processing can be implemented.

### Fourth Embodiment

In each of the embodiments described above, a case has been described where a map corresponding to future image data is predicted on a time axis from a map corresponding to past image data on the time axis by processing image data buffered by the buffer unit 121 according to chronological order.

In contrast, in a fourth embodiment, image data is processed in an order different from the chronological order in which the image data is buffered by the buffer unit 121 (for example, rearrange and process image data). Moreover, in the fourth embodiment, a map corresponding to image data sandwiched between preceding and subsequent pieces of image data on the time axis is predicted based on each map corresponding to the preceding and subsequent pieces of the image data.

For example, in the fourth embodiment,
for image data buffered by the buffer unit 121 in chronological order of the first time (=t) the second time (=t+x) a fourth time (=t+z) (however, x<z),
the image data is rearranged and processed in chronological order of the first time (=t)→the fourth time (=t+z)→the second time (=t+x). Then, a map corresponding to the image data at the second time (=t+x) is predicted based on a map corresponding to the image data at the first time (=t) and a map corresponding to the image data at the fourth time (=t+z).

In this way, in the fourth embodiment, the image data is rearranged, and a map corresponding to the image data sandwiched between the preceding and subsequent pieces of the image data on the time axis is predicted. As a result, according to the fourth embodiment, as compared with a case where the map corresponding to the future image data is predicted from the map corresponding to the past image data on the time axis, prediction accuracy can be improved. Hereinafter, regarding the fourth embodiment, differences from the first embodiment will be mainly described.

### <System Configuration of Image Processing System>

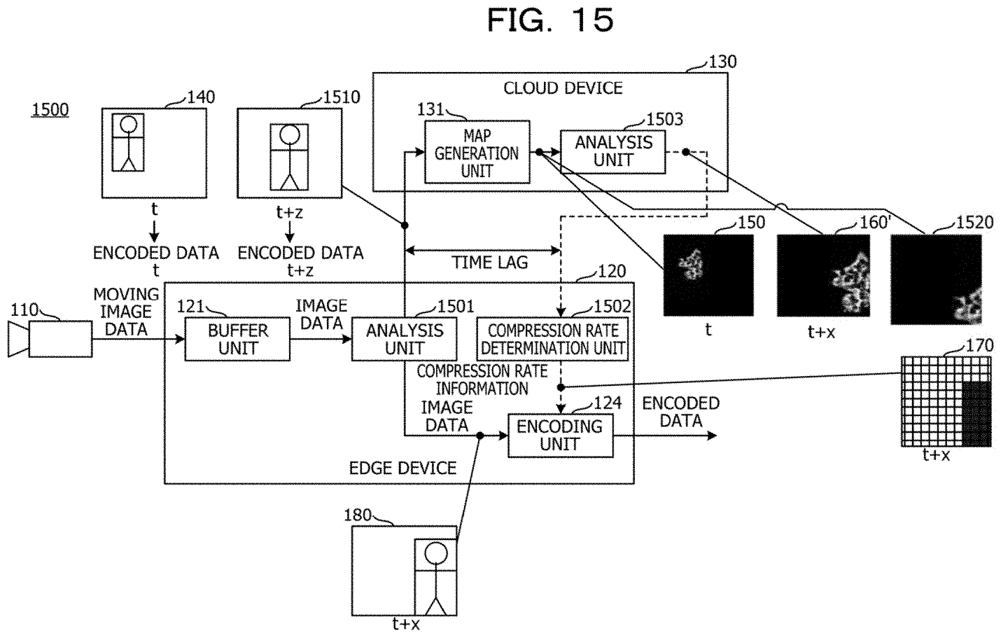

First, a system configuration of an image processing system according to a fourth embodiment will be described. FIG. 15 is a fourth diagram illustrating an example of the system configuration of the image processing system. As illustrated in FIG. 15, in a case of an image processing system 1500, there are the following differences from the image processing system 100 in FIG. 1.

For example, an analysis unit 1501 of an edge device 120 reads image data 1510 buffered at the fourth time (=t+z) that is a predetermined time (=z>x) after the first time (=t), notifies an encoding unit 124 of the image data 1510, and encodes the image data 1510. Then, the analysis unit 1501 of the edge device 120 transmits the encoded data obtained by encoding the image data 1510 buffered at the fourth time (=t+z) to a cloud device 130.

For example, in a case of the analysis unit 1501 of the edge device 120, before reading image data 1010 (not illustrated in FIG. 15) buffered at a third time (=t+x), the image data 1510 buffered at the fourth time (=t+z) is read. As a result, the image data 1010 and the image data 1510 are rearranged.

Furthermore, a difference from the image processing system 100 in FIG. 1 is a point that a compression rate determination unit 1502 of the edge device 120 generates compression rate information 170 based on a map 160′ transmitted from the cloud device 130.

Moreover, a difference from the image processing system 100 in FIG. 1 is a point that the cloud device 130 includes an analysis unit 1503, and the analysis unit 1503 predicts the map 160′ corresponding to image data 180 at the second time (=t+x) based on
a map 150 corresponding to image data 140 at the first time (=t) and
a map 1520 corresponding to the image data 1510 at the fourth time (=t+z).

Note that it is assumed that a predetermined time (=z) be adjusted so that the number of pieces of image data buffered between the first time (=t) and the fourth time (=t+z) is a number needed to form a bidirectional reference encoding structure for general moving image encoding processing.

### <Specific Example of Processing of Edge Device>

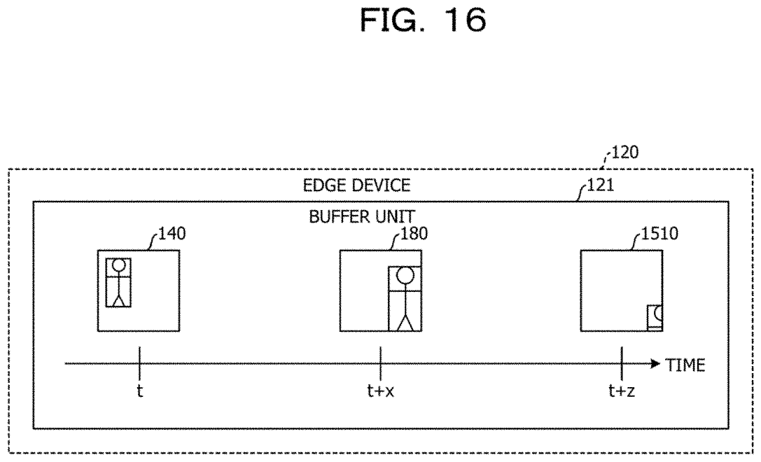

Next, a specific example of processing of the edge device 120 (here, specific example of processing of buffer unit 121) will be described. FIG. 16 is a third diagram illustrating a specific example of the processing of the buffer unit of the edge device. As illustrated in FIG. 16, the buffer unit 121 of the edge device 120 buffers image data of a predetermined number of frames among image data of each frame included in moving image data transmitted from an imaging device 110. In the fourth embodiment, the image data buffered by the buffer unit 121 of the edge device 120 includes the image data 140 at the first time (=t), the image data 180 at the second time (=t+x), and the image data 1510 at the fourth time (=t+z).

Note that, as in the first embodiment described above, a plurality of pieces of buffered image data may exist between the second time (=t+x) and the fourth time (=t+z).

### <Specific Example of Functional Configuration and Processing of Cloud Device>

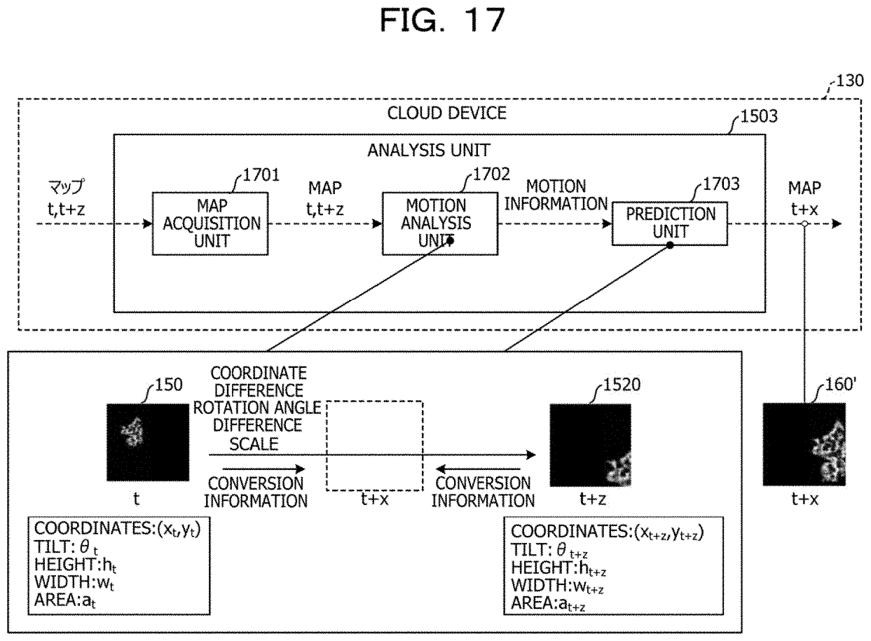

Next, a specific example of a functional configuration and processing of the analysis unit 1503 of the cloud device 130 will be described with reference to FIG. 17. FIG. 17 is a second diagram illustrating a specific example of a functional configuration and processing of the analysis unit of the cloud device.

As illustrated in FIG. 17, the analysis unit 1503 of the cloud device 130 includes a map acquisition unit 1701, a motion analysis unit 1702, and a prediction unit 1703.

The map acquisition unit 1701 acquires a pair of maps notified from a map generation unit 131. For example, the map acquisition unit 1701 acquires a pair of the map 150 corresponding to the image data 140 at the first time (=t) and the map 1520 corresponding to the image data 1510 at the fourth time (=t+z) that are generated by the map generation unit 131. Furthermore, the map acquisition unit 1701 notifies the motion analysis unit 1702 of the acquired pair of maps.

The motion analysis unit 1702 calculates a change amount of the map generated in the time z, based on the pair of maps notified from the map acquisition unit 1701 and generates motion information based on the calculated change amount.

For example, the motion analysis unit 1702 calculates features such as coordinates, tilt, a height, a width, or an area of a region corresponding to an object included in the map 150. Furthermore, for example, the motion analysis unit 1702 calculates features such as coordinates, tilt, a height, a width, or an area of a region corresponding to an object included in the map 1520.

Moreover, the motion analysis unit 1702 analyzes a motion of a region corresponding to an object at the second time (=t+x), for example, by calculating a coordinate difference, a rotation angle difference, a vertical and horizontal scale ratio, or the like that is a change amount of a feature between the map 150 and the map 1520 and generates motion information. Furthermore, the motion analysis unit 1702 notifies the prediction unit 1703 of the generated motion information.

The prediction unit 1703 generates conversion information used to predict the map 160′ corresponding to the image data 180 at the second time (=t+x) by converting
the map 150 corresponding to the image data 140 at the first time (=t) and
the map 1520 corresponding to the image data 1510 at the fourth time (=t+z),
based on the motion information notified by the motion analysis unit 1702. Furthermore, the prediction unit 1703, based on the generated conversion information, predicts the map 160′ corresponding to the image data 180 at the second time (=t+x) from
the map 150 corresponding to the image data 140 at the first time (=t) and
the map 1520 corresponding to the image data 1510 at the fourth time (=t+z). Note that the map 160′ predicted by the prediction unit 1703 is transmitted to the edge device 120.

### <Flow of Encoding Processing by Image Processing System>

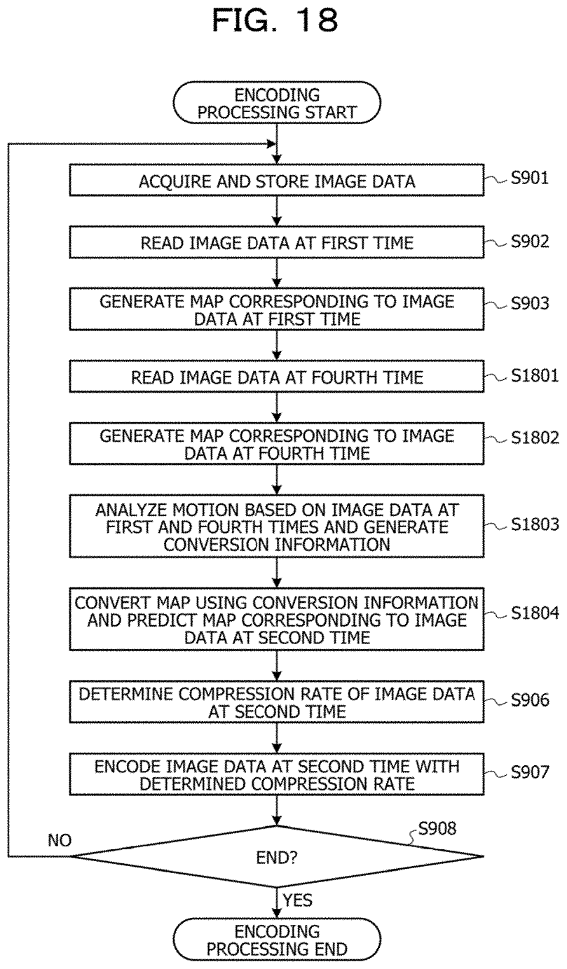

Next, a flow of encoding processing executed by the entire image processing system 1500 will be described. FIG. 18 is a third flowchart illustrating the flow of the encoding processing by the image processing system. The difference from FIG. 9 is steps S1801 to S1804.

In step S1801, the analysis unit 1501 of the edge device 120 reads image data at the fourth time (=t+z) from the image data buffered by the buffer unit 121, notifies the encoding unit 124 of the image data, and encodes the image data, and then, transmits the image data to the cloud device 130.

In step S1802, the map generation unit 131 of the cloud device 130 generates a map corresponding to the image data at the fourth time (=t+z).

In step S1803, the analysis unit 1503 of the cloud device 130 calculates a change amount from the map corresponding to the image data at the fourth time (=t+z) from the map corresponding to the image data at the first time (=t). As a result, the analysis unit 1503 of the cloud device 130 analyzes a motion of a region corresponding to an object at the second time (=t+x) and generates motion information. Furthermore, the analysis unit 1503 of the cloud device 130 generates conversion information used to predict the map corresponding to the image data at the second time (=t+x), based on the generated motion information.

In step S1804, the analysis unit 1503 of the cloud device 130 converts the maps corresponding to the image data at the first time (=t) and the fourth time (=t+x), using the generated conversion information. As a result, the analysis unit 1503 of the cloud device 130 predicts the map corresponding to the image data at the second time (=t+x).

As is clear from the above description, the image processing system 1500 according to the fourth embodiment predicts the map corresponding to the image data at the second time based on the map corresponding to the image data at the first time and the fourth time and the motion of the region corresponding to the object at the second time. As a result, according to the image processing system 1500 according to the fourth embodiment, effects similar to the first embodiment described above can be achieved.

### Fifth Embodiment

In the first to fourth embodiments described above, it has been described as assuming that all the pieces of the image data of each frame of the moving image data transmitted from the imaging device 110 is transmitted to the cloud device 130. In contrast, in a fifth embodiment, some pieces of image data among the image data of each frame of the moving image data is transmitted to the cloud device 130, and the cloud device 130 generates a map corresponding to the some pieces of image data. Furthermore, in the fifth embodiment, a map corresponding to another piece of the image data sandwiched between the some pieces of the image data for which the map is generated is predicted based on the map corresponding to the some pieces of the image data. Hereinafter, regarding the fifth embodiment, differences from the first embodiment described above will be mainly described.

### <System Configuration of Image Processing System>

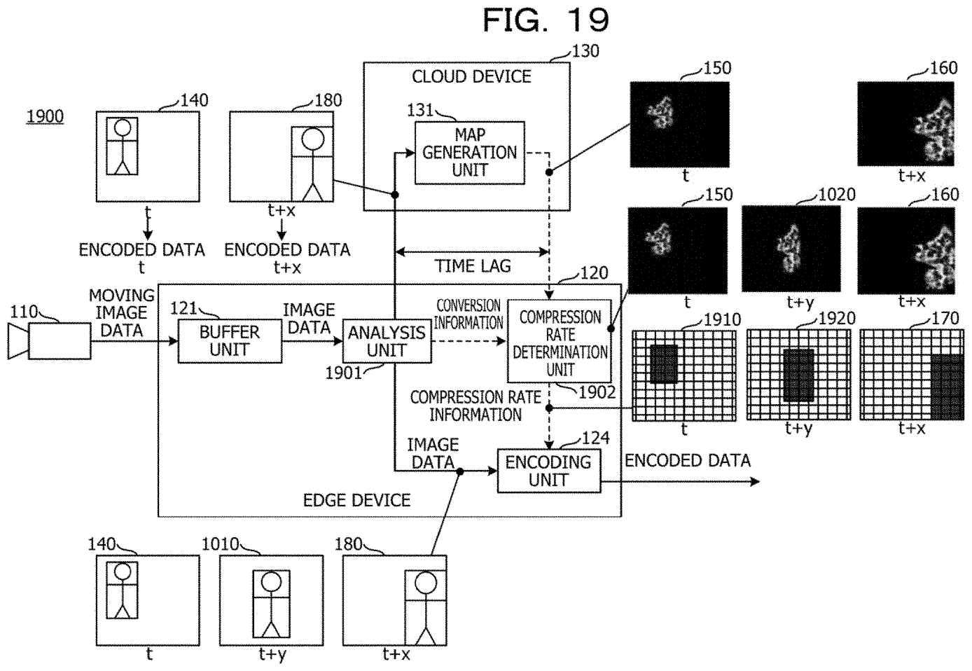

First, a system configuration of an image processing system according to the fifth embodiment will be described. FIG. 19 is a fifth diagram illustrating an example of the system configuration of the image processing system. Differences from the image processing systems 100, 1000, 1400, and 1500 in FIGS. 1, 10, 14, and 15 are an analysis unit 1901 and a compression rate determination unit 1902.

As illustrated in FIG. 19, in a case of an image processing system 1900, the analysis unit 1901 reads image data 140 buffered at a first time (=t), notifies an encoding unit 124 of the image data 140, and encodes the image data 140, and then, transmits the encoded data to the cloud device 130. Furthermore, the analysis unit 1901 reads image data 180 buffered at a second time (=t+x) that is a predetermined time (=x) after the first time (=t), notifies the encoding unit 124 of the image data 180, and encodes the image data 180, and then, transmits the encoded data to the cloud device 130.

Furthermore, the analysis unit 1901 reads all pieces of image data (in example in FIG. 19, only image data 1010 is illustrated due to space limitation) buffered between the first time (=t) and the second time (=t+x) and notifies the encoding unit 124 of the image data.

Moreover, the analysis unit 1901 generates conversion information from preceding and subsequent pieces of image data, for all the pieces of the image data buffered between the first time (=t) and the second time (=t+x) and notifies the compression rate determination unit 1902 of the conversion information. For example, the analysis unit 1901 generates conversion information from the image data 140 and the image data 180 that are the preceding and subsequent pieces of the image data for the image data 1010 and notifies the compression rate determination unit 1902 of the conversion information.

The compression rate determination unit 1902 acquires a map 150 that is a map calculated by the cloud device 130 and corresponds to the image data at the first time (=t) and a map 160 corresponding to the image data 180 at the second time (=t+x). Furthermore, the compression rate determination unit 1902 converts the acquired maps 150 and 160 based on the conversion information notified by the analysis unit 1901 and predicts a map 1020 corresponding to the image data 1010 at a third time (=t+y).

Furthermore, the compression rate determination unit 1902 converts the acquired map 150 and the predicted map 1020 based on another piece of the conversion information notified by the analysis unit 1901 and predicts a map corresponding to image data (not illustrated) at a time between the first time and the third time.

Similarly, the compression rate determination unit 1902 converts the predicted map 1020 and the calculated map 160 based on the another piece of the conversion information notified by the analysis unit 1901 and predicts a map corresponding to image data (not illustrated) at a time between the third time and the second time. Thereafter, by repeating the similar processing, the compression rate determination unit 1902 predicts maps corresponding to all pieces of image data included between the first time (=t) and the second time (=t+x).

Moreover, the compression rate determination unit 1902 determines a compression rate of each processing block that is used when the image data at the first time (=t) is encoded based on the map corresponding to the image data at the first time (=t) and generates compression rate information 1910. Furthermore, the compression rate determination unit 1902 determines a compression rate of each processing block that is used when the image data at the second time (=t+x) is encoded based on the map corresponding to the image data at the second time (=t+x) and generates compression rate information 170. Moreover, the compression rate determination unit 1902 determines a compression rate of each processing block that is used when each image data between the first time (=t) and the second time (=t+x) is encoded, based on each map corresponding to each piece of the image data between the first time (=t) and the second time (=t+x). Moreover, the compression rate determination unit 1902 generates compression rate information including the determined compression rate of each processing block. The example in FIG. 19 illustrates a state where the compression rate determination unit 1902 determines the compression rate of each processing block that is used when the image data 1010 is encoded and generates compression rate information 1920.

### <Specific Example of Functional Configuration And Processing of Each Unit of Edge Device>

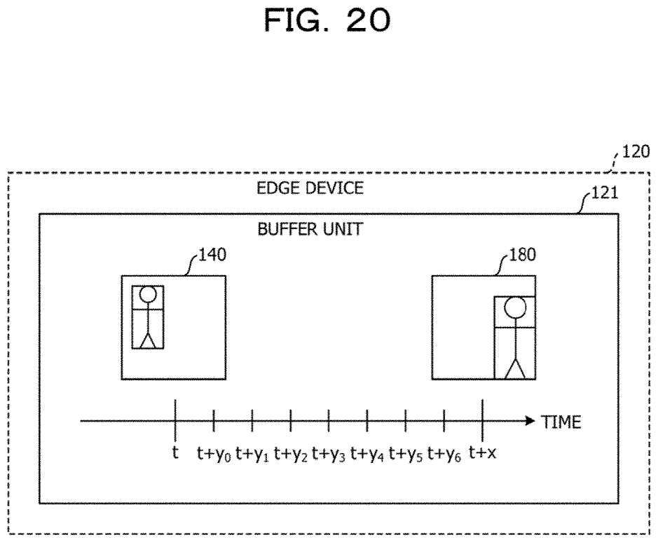

Next, a specific example of a functional configuration and/or processing of each unit of an edge device 120 will be described with reference to FIGS. 20 to 22.
(1) Specific Example of Processing of Buffer Unit

FIG. 20 is a fourth diagram illustrating a specific example of processing of a buffer unit of the edge device. As illustrated in FIG. 19, a buffer unit 121 of the edge device 120 buffers image data of a predetermined number of frames among image data of each frame included in the moving image data transmitted from the imaging device 110. In the fifth embodiment, the image data buffered by the buffer unit 121 of the edge device 120 includes the image data 140 at the first time (=t), the image data 180 at the second time (=t+x), and the image data at each time between the first time and the second time.

The example in FIG. 20 illustrates that image data of seven frames of times t+y₀ to t+y₆ is buffered as the image data at each time between the first time and the second time.
(2) Specific Example of Functional Configuration And Processing of Analysis Unit

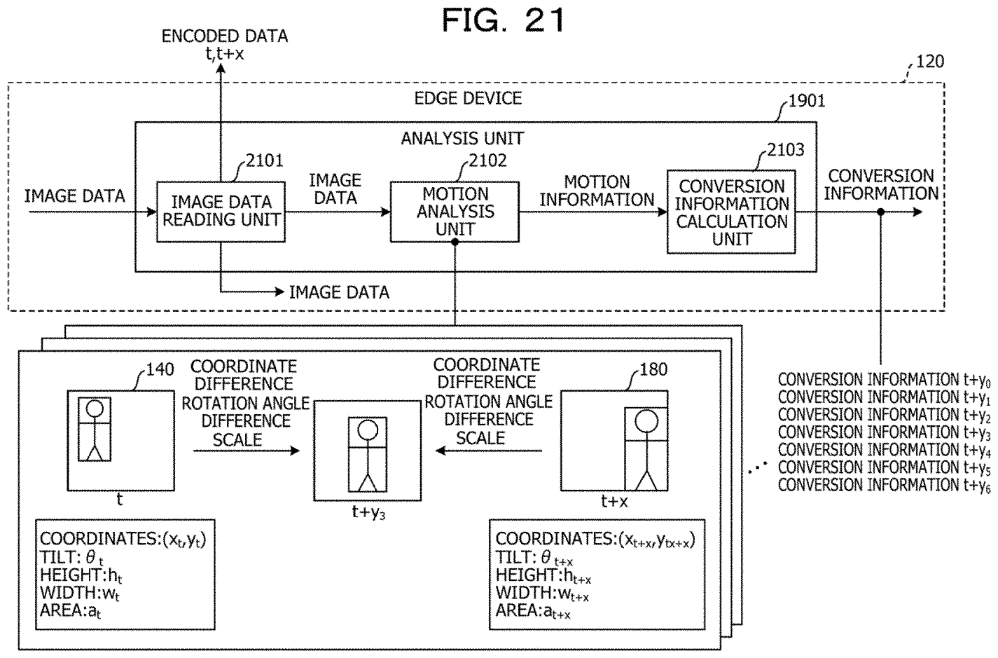

Next, a specific example of a functional configuration and processing of the analysis unit 1901 will be described. FIG. 21 is a second diagram illustrating a specific example of a functional configuration and processing of the analysis unit of the edge device. As illustrated in FIG. 21, the analysis unit 1901 includes an image data reading unit 2101, a motion analysis unit 2102, and a conversion information calculation unit 2103.

The image data reading unit 2101 reads image data buffered by the buffer unit 121 (for example, from image data at first time to image data at second time). Furthermore, the image data reading unit 2101 notifies the motion analysis unit 2102 and the encoding unit 124 of the read image data. Furthermore, the image data reading unit 2101 transmits the encoded data of the image data at the first time (=t) and the image data at the second time (=t+x) that are encoded by the encoding unit 124, of the read image data, to the cloud device 130.

The motion analysis unit 2102 generates a pair of pieces of image data based on the image data notified by the image data reading unit 2101 and calculates a change amount of image data sandwiched between the generated pair based on the generated pair so as to generate motion information.

For example, a motion of an object at the time t+y₃ is analyzed by calculating a change amount of the image data at the time t+y₃ based on a pair of the image data at the first time (=t) and the image data at the second time (=t+x), and the motion information is generated. Furthermore, a motion of an object at the time t+y₁ is analyzed by calculating a change amount of the image data at the time t+y₁ based on a pair of the image data at the first time (=t) and the image data at the time t+y₃, and the motion information is generated. Furthermore, a motion of an object at the time t+y₅ is analyzed by calculating a change amount of the image data at the time t+y₅ based on a pair of the image data at the time t+y₃ and the image data at the second time (=t+x), and the motion information is generated.

Hereinafter, similarly,
a motion of an object at the time t+y₀ is analyzed by calculating a change amount of the image data at the time t+y₀ based on a pair of the image data at the first time (=t) and the image data at the time t+y₁, and the motion information is generated.
A motion of an object at the time t+y₂ is analyzed by calculating a change amount of the image data at the time t+y₂ based on a pair of the image data at the time t+y₁ and the image data at the time t+y₃, and the motion information is generated.
A motion of an object at the time t+y₄ is analyzed by calculating a change amount of the image data at the time t+y₄ based on a pair of the image data at the time t+y₃ and the image data at the time t+y₅, and the motion information is generated.
A motion of an object at the time t+y₆ is analyzed by calculating a change amount of the image data at the time t+y₆ based on a pair of the image data at the time t+y₅ and the image data at the second time (=t+x), and the motion information is generated.

The conversion information calculation unit 2103 generates the conversion information that is used to predict a map corresponding to the image data sandwiched between the pair of pieces of image data, from the pair of maps corresponding to the pair of pieces of image data, based on each piece of the motion information notified by the motion analysis unit 2102. The example in FIG. 21 illustrates a state where the conversion information calculation unit 2103 generates conversion information t+y₀ to t+y₆.
(2) Specific Example of Functional Configuration And Processing of Compression Rate Determination Unit

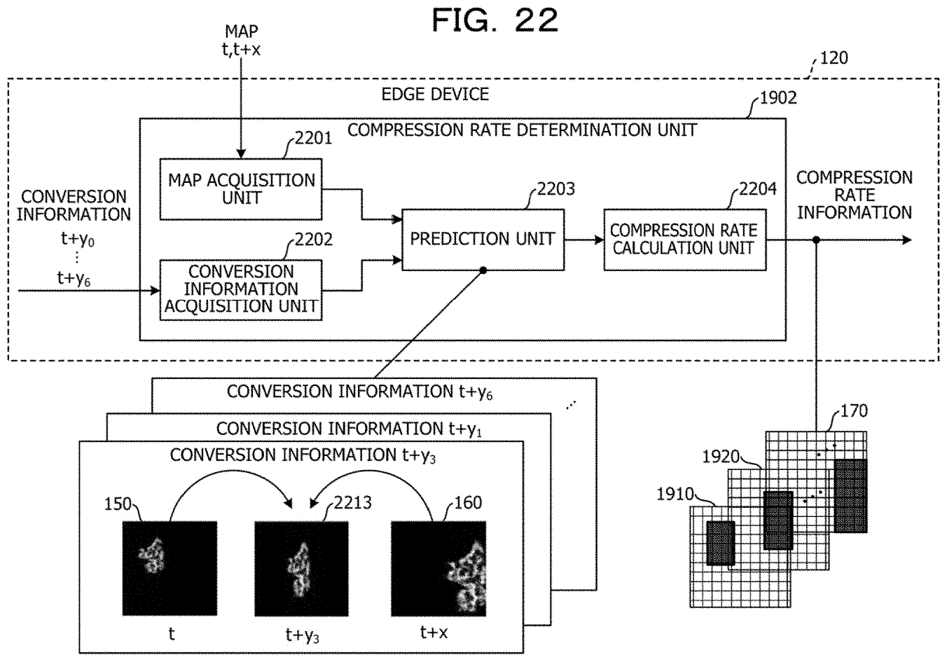

Next, a specific example of a functional configuration and processing of the compression rate determination unit 1902 will be described. FIG. 22 is a second diagram illustrating a specific example of a functional configuration and processing of the compression rate determination unit of the edge device. As illustrated in FIG. 22, the compression rate determination unit 1902 includes a map acquisition unit 2201, a conversion information acquisition unit 2202, a prediction unit 2203, and a compression rate calculation unit 2204.

The map acquisition unit 2201 acquires the map (for example, maps 150 and 160 corresponding to image data 140 and 180 at first time (=t) and second time (=t+x)) from the cloud device 130 and notifies the prediction unit 2203 of the map.

The conversion information acquisition unit 2202 acquires conversion information (for example, conversion information t+y₀ to t+y₆ generated for image data of each frame between first time (=t) and second time (=t+x)) from the analysis unit 1901. Furthermore, the conversion information acquisition unit 2202 notifies the prediction unit 2203 of the acquired conversion information t+y₀ to t+y₆.

The prediction unit 2203 notifies the compression rate calculation unit 2204 of the map 150 corresponding to the image data at the first time (=t) and the map 160 corresponding to the image data at the second time (=t+x) notified from the map acquisition unit 2201.

Furthermore, the prediction unit 2203 predicts a map corresponding to the image data at each time between the first time (=t) and the second time (=t+x). For example,
a map 2213 corresponding to the image data at the time t+y₃ is predicted, based on the map 150 corresponding to the image data at the first time (=t), the map 160 corresponding to the image data at the second time (=t+x), and the conversion information t+y₃.
A map corresponding to the image data at the time t+y₁ is predicted, based on the map 150 corresponding to the image data at the first time (=t), the map 2213 corresponding to the image data at the time t+y₃, and the conversion information t+y₁.
A map corresponding to the image data at the time t+y₆ is predicted, based on the map corresponding to the image data at the time t+y₆, the map 160 corresponding to the image data 180 at the second time (t+x), and the conversion information t+y₆.

The compression rate calculation unit 2204 determines a compression rate of each processing block based on the map notified from the prediction unit 2203 and generates compression rate information. For example, the compression rate calculation unit 2204
determines a compression rate of each processing block based on the map 150 corresponding to the image data 140 at the first time (=t) and generates the compression rate information 1910.
determines a compression rate of each processing block based on the map 2213 corresponding to the image data at the time t+y₃ and generates the compression rate information 1920.
determines a compression rate of each processing block based on the map 160 corresponding to the image data 180 at the second time (=t+x) and generates the compression rate information 170.

### <Flow of Encoding Processing by Image Processing System>

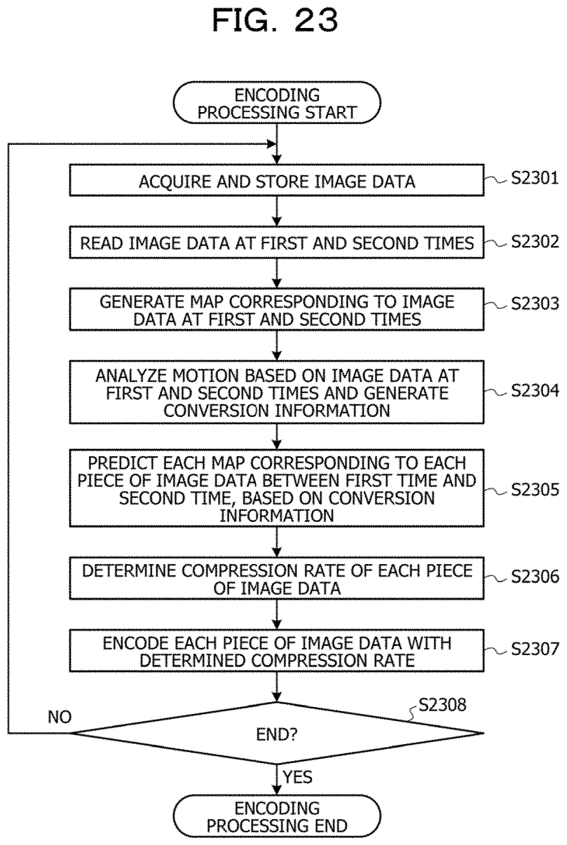

Next, a flow of encoding processing executed by the entire image processing system 1900 will be described. FIG. 23 is a fourth flowchart illustrating the flow of the encoding processing by the image processing system.

In step S2301, the buffer unit 121 of the edge device 120 acquires image data of each frame of the moving image data transmitted from the imaging device 110 and buffers the image data.

In step S2302, an analysis unit 1501 of the edge device 120 reads the image data at the first time (=t) and the second time (=t+x) from the image data buffered by the buffer unit 121. Furthermore, the analysis unit 1501 of the edge device 120 notifies the encoding unit 124 of the read image data at the first time (=t) and the second time (=t+x) and encodes the read image data, and then, transmits the image data to the cloud device 130.

In step S2303, a map generation unit 131 of the cloud device 130 generates maps respectively corresponding to the image data at the first time (=t) and the image data at the second time (=t+x) and transmits the maps to the edge device 120.

In step S2304, the analysis unit 1901 of the edge device 120 analyzes a motion of an object at each time between the first time (=t) and the second time (=t+x) and generates motion information. Furthermore, the analysis unit 1901 of the edge device 120 generates conversion information corresponding to the image data at each time between the first time (=t) and the second time (=t+x), based on the generated motion information.

In step S2305, the compression rate determination unit 1902 of the edge device 120 predicts each map corresponding to the image data at each time between the first time (=t) and the second time (=t+x), based on the generated conversion information.

In step S2306, the compression rate determination unit 1902 of the edge device 120 determines a compression rate of each processing block used when each piece of the image data between the first time (=t) and the second time (=t+x) is encoded, based on each map and generates each piece of compression rate information.

In step S2307, the encoding unit 124 of the edge device 120 encodes each piece of the image data between the first time (=t) and the second time (=t+x), using each piece of the corresponding compression rate information.

In step S2308, the edge device 120 determines whether or not to end the encoding processing. In a case where it is determined to continue the encoding processing in step S2308 (a case of NO in step S2308), the procedure returns to step S2301. In this case, the image processing system 1900 executes similar processing as assuming a time obtained by advancing the second time (=t+x) by a frame period as the first time.

On the other hand, in a case where it is determined to end the encoding processing in step S2308 (a case of YES in step S2308), the encoding processing ends.

As is clear from the above description, the image processing system 1900 according to the fifth embodiment transmits some pieces of the image data among the image data of each frame of the moving image data to the cloud device 130 and generates the map. Furthermore, the image processing system 1900 according to the fifth embodiment predicts the map corresponding to the image data among the some pieces of the image data, based on the generated map and the motion of the object at the time when the image data among the some piece of the image data is acquired. As a result, according to the fifth embodiment, while effects similar to those of each embodiment described above are achieved, it is possible to further reduce a communication amount between the edge device 120 and the cloud device 130.

### Sixth Embodiment

In the first to fifth embodiments described above, a case has been described where the encoded data obtained by encoding the image data is transmitted from the edge device 120 to the cloud device 130 and the map is transmitted from the cloud device 130 to the edge device 120. However, information transmitted from the edge device 120 to the cloud device 130 is not limited to the encoded data. Furthermore, information transmitted from the cloud device 130 to the edge device 120 is not limited to the map.

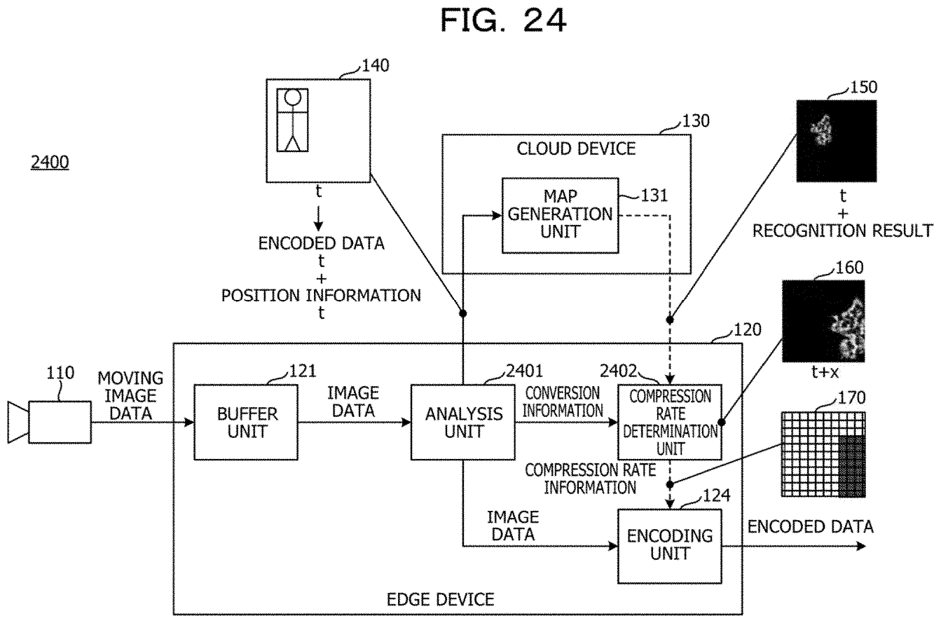

FIG. 24 is a sixth diagram illustrating an example of a system configuration of an image processing system. As illustrated in FIG. 24, in an image processing system 2400, for example, when transmitting image data 140 at a first time (=t), an analysis unit 2401 of the edge device 120 may transmit position information indicating a position of an object included in the image data 140. As a result, when executing image recognition processing on the image data 140, a map generation unit 131 of the cloud device 130 can input the position information together. As a result, recognition accuracy for the image data 140 is improved, and the map generation unit 131 can generate a more appropriate map 150.

Furthermore, as illustrated in FIG. 24, in the image processing system 2400, for example, when transmitting the map 150, the map generation unit 131 of the cloud device 130 may transmit a processing result (recognition result) of the image recognition processing on the image data 140. As a result, when predicting a map 160 based on conversion information, a compression rate determination unit 2402 of the edge device 120 can predict a more appropriate map by using the recognition result.

As is clear from the above description, in the image processing system 2400 according to the sixth embodiment, information obtained when each of the edge device 120 and the cloud device 130 executes processing is transmitted to each other. As a result, the edge device 120 and the cloud device 130 can realize more appropriate processing.

### Other Embodiments

In the fifth embodiment described above, it is described as assuming that, when each piece of the image data between the first time (=t) and the second time (=t+x) is buffered, the encoded data of the image data at the first time (=t) and the second time (=t+x) is transmitted to the cloud device 130. However, the encoded data of each piece of the image data between the first time (=t) and the second time (=t+x) may be transmitted to the cloud device 130. In this case, a compression rate calculation unit 2204 may determine a compression rate based on a map predicted by a prediction unit 2203 and a map generated by the cloud device 130.

Furthermore, in the fourth embodiment described above, a case has been described where the buffered image data is rearranged and processed. However, this is for increasing map prediction accuracy and lowering map prediction difficulty. As is clear from the above description, in a case where rearrangement is not performed, image data in which the map generated by the cloud device 130 is reflected is future image data in a case of being viewed from the cloud device 130. On the other hand, in a case where rearrangement is performed, a plurality of pieces of image data can be sandwiched between pieces of image data for which maps have been already generated.

In this case, a motion of a region corresponding to an object included in the sandwiched image data is analyzed based on image data at a time when the position of the object is determined and image data at a time when the position of the object is similarly determined after the time above. As a result, it is possible to increase the map prediction accuracy and lower the map prediction difficulty.

Note that, in a case of the fourth embodiment described above, unlike a case where general moving image encoding processing rearranges and encodes image data, standard rearrangement is not performed. This is because information used to determine the compression rate may be transmitted from the cloud device at a timing that does not necessarily match the standard rearrangement. Therefore, in the fourth embodiment described above, instead of performing standard rearrangement and executing the encoding processing, the encoding processing is executed at a timing when encoding can be performed. As a result, according to the fourth embodiment described above, it is possible to reduce a difference between a transmission time between the cloud device and the edge device or a map generation time by the cloud device and a time lag after rearrangement.

Furthermore, although it has been described as assuming that the map generated by the map generation unit according to each embodiment described above has information with a pixel granularity, the map does not necessarily need to include the information with the pixel granularity. Therefore, the generated map may be converted into a map that includes information with a different granularity, for example.

For example, the map may be converted into a map that has information aggregated for each predetermined region, a statistic amount of the information aggregated for each predetermined region, or information indicating a compression rate such as a quantized value for each predetermined region. In this case, the edge device 120 includes a first compression rate determination unit that generates a map including information with the pixel granularity and a second compression rate determination unit that converts the map including the information with the pixel granularity into a map including information with a different granularity.

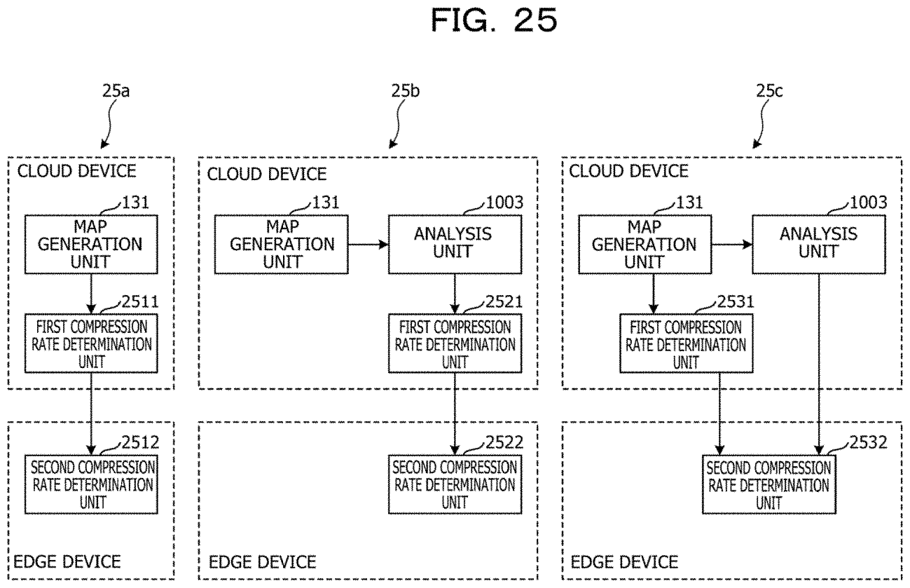

FIG. 25 is a conceptual diagram illustrating an image processing system that can perform conversion into a map including information with a different granularity. In FIG. 25, 25a indicates a conceptual diagram in a case where the image processing system 100 (FIG. 1) is transformed into an image processing system that can perform conversion into a map including information with a different granularity by including a first compression rate determination unit 2511 and a second compression rate determination unit 2512.

Furthermore, 25b indicates a conceptual diagram in a case where the image processing system 1000 (FIG. 10) is transformed into an image processing device that can perform conversion into a map including information with a different granularity by including a first compression rate determination unit 2521 and a second compression rate determination unit 2522.

Moreover, 25c illustrates a state where the image processing system 1400 (FIG. 14) is transformed into an image processing system that can perform conversion into a map including information with a different granularity by including a first compression rate determination unit 2531 and a second compression rate determination unit 2532.

In this way, by performing conversion into a map including information with a different granularity, for example, it is possible to reduce an amount of data transmitted from the cloud device to the edge device. Furthermore, in a case of the map including the information with the pixel granularity, a calculation amount when a motion of a region corresponding to an object is large. However, by performing conversion into the map including the information having the different granularity, it is possible to reduce the calculation amount. Moreover, in a case of the map including the information with the pixel granularity, there is a possibility that the map prediction accuracy is affected by a noise of the pixel granularity. However, by performing conversion into the map including the information with the different granularity, it is possible to reduce the effect of the noise with the pixel granularity.

Furthermore, in each embodiment described above, it has been described as assuming that the image processing system includes the cloud device and the edge device. However, the cloud device does not necessarily need to be on the cloud, and may be arranged in a state of having a time lag with the map generation unit, the analysis unit, and the encoding unit.

For example, the cloud device and the map device included in the image processing system may be an edge device that is arranged at a predetermined site where a video analysis device is placed and a center device that functions as an aggregation device in the site. Alternatively, it may be a device group that is connected under an environment where a time lag occurs due to a cause different from a time lag caused through a network.

Furthermore, in each embodiment described above, it is assumed that the map is generated so that the feature portion acquired from the image data and the feature portion focused when the AI executes the image recognition processing effectively act. However, the map may be generated using some of the feature portions.

Note that the embodiments are not limited to the configurations described above and may include, for example, combinations of the configurations or the like described in the above embodiments with other elements. These points may be changed without departing from the spirit of the embodiments and may be appropriately assigned according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing system comprising:
a memory; and
a processor coupled to the memory and configured to:
generate information that indicates a feature portion that affects image recognition processing, by executing image recognition processing on first image data acquired at a first time;
predict information that indicates the feature portion at a second time after the first time, based on the information that indicates the feature portion at the first time; and
encode second image data acquired at the second time, by using a compression rate based on the predicted information that indicates the feature portion.

2. The image processing system according to claim 1, wherein
the processor:
analyzes a motion o an object at the second time based on a feature of the object included in the first image data, and a feature of the object included in the second image data, and
predicts information that indicates a first feature portion at the second time, based on the information that indicates the feature portion at the first time, and the analyzed motion of the object at the second time.

3. The image processing system according to claim 2, wherein
the processor:
analyzes a motion of a region of an object at a third time between the first time and the second time is analyzed, based on a feature of the region of the object, calculated based on the information that indicates the feature portion at the first time, and a feature of a region of the object calculated based on the information that indicates the feature portion at the third time generated by executing image recognition processing on third image data that is acquired at the third time, and
predicts information that indicates the second feature portion at the second time, based on the information that indicates the feature portion at the third time, and the analyzed motion of the region of the object at the third time.

4. The image processing system according to claim 3, wherein
the processor encodes the second image data, by using a compression rate based on the information that indicates the first feature portion, and the information that indicates the second feature portion.

5. The image processing system according to claim 1, wherein
the processor:
generates the information that indicates the feature portion in an order different from an order in which image data is acquired, and
performs prediction by using the information that indicates the feature portion generated by executing image recognition processing on preceding and subsequent pieces of image data on a time axis, when predicting the information that indicates the feature portion.

6. The image processing system according to claim 5, wherein
the processor:
analyzes a motion of a region of an object at the second time, based on a feature of the region of the object calculated based on the information that indicates the feature portion at the first time, and a feature of a region of the object calculated based on information that indicates the feature portion at a fourth time generated by executing image recognition processing on fourth image data that is acquired at the fourth time after the second time, and
predicts the information that indicates the feature portion at the second time, based on the information that indicates the feature portion at the first time, the information that indicates the feature portion at the fourth time, and the analyzed motion of the region of the object at the second time.

7. The image processing system according to claim 1, wherein
the processor:
generates information that indicates the feature portion by executing image recognition processing on some pieces of image data of a plurality of pieces of acquired image data, and
performs prediction by using the information that indicates the feature portion generated for preceding and subsequent piece of image data on a time axis, when predicting the information that indicates the feature portion.

8. The image processing system according to claim 7, wherein
the processor:
analyzes a motion of an object at the second time based on a feature of the object included in the first image data, and a feature of the object included in fourth image data acquired at a fourth time after the second time, and
predicts the information that indicates the feature portion at the second time, based on the information that indicates the feature portion at the first time, information that indicates the feature portion at the fourth time generated by executing image recognition processing on the fourth image data, and the analyzed motion of the object at the second time.

9. The image processing system according to claim 8, wherein
the processor encodes the second image data, by using a compression rate based on the information that indicates the feature portion at the second time and is predicted, and the information that indicates the feature portion at the second time generated by executing image recognition processing on the second image data.

10. The image processing system according to claim 1, wherein
the processor aggregates the predicted information that indicates the feature portion for each processing block used when the second image data is encoded, and encodes the second image data, by using a compression rate for each processing block determined based on an aggregation result.

11. An image processing device comprising:
a memory; and
a processor coupled to the memory and configured to:
generate information that indicates a feature portion that affects image recognition processing, by executing image recognition processing on first image data acquired at a first time;
predict information that indicates the feature portion at a second time after the first time, based on the information that indicates the feature portion at the first time; and
encode second image data acquired at the second time, by using a compression rate based on the predicted information that indicates the feature portion.

12. A non-transitory computer-readable recording medium storing an image processing program causing a computer to execute a processing of:
generating information that indicates a feature portion that affects image recognition processing, by executing image recognition processing on first image data acquired at a first time;
predicting information that indicates the feature portion at a second time after the first time, based on the information that indicates the feature portion at the first time; and
encoding second image data acquired at the second time, by using a compression rate based on the predicted information that indicates the feature portion.
